(19) United States
(12) Patent Application Publication
(10) Pub. No.: US 2026/0332673 A1
(43) Pub. Date: Oct. 22, 2026

(54) SYSTEM AND METHOD FOR CONTROLLING AN ADULT TOY

(71) Applicant: HYTTO PTE. LTD, Singapore (SG)

(72) Inventors: Dan Liu, Singapore (SG); Jilin Qiu, Singapore (SG)

(21) Appl. No.: 19/433,752

(22) Filed: Dec. 27, 2025

Related U.S. Application Data
(60) Provisional application No. 63/791,003, filed on Apr. 18, 2025.

(51) Int. Cl. H04L 67/131; A61H 9/00; A61H 19/00; A61H 23/02; G06Q 20/42; H04L 67/00; H04L 67/104

(52) U.S. Cl. CPC H04L 67/131; A61H 9/0057; A61H 19/44; A61H 23/02; G06Q 20/42; H04L 67/104; H04L 67/34; A61H 2201/0207; A61H 2201/0228; A61H 2201/1207; A61H 2201/5012; A61H 2201/5035; A61H 2201/5043; A61H 2201/5048; A61H 2201/5092; A61H 2201/5097; A61H 2205/087

(57) ABSTRACT

A method for controlling a sex toy of a model user is disclosed. The method includes controlling a first control node to establish a communication connection with a livestreaming platform, generating a control instruction for the sex toy of the model user in response to an interactive event initiated by a viewer user of the livestreaming platform toward the model user, and controlling the first control node to obtain a network resource identifier of a second control node. The first control node and the second control node are both located within a same data transmission network, and the same data transmission network is configured to allow the first control node and the second control node to transmit data via peer-to-peer communication. The second control node establishes a communication link, which is wired or wireless, with a control module embedded in the sex toy of the model user.

### CROSS-REFERENCE TO RELATED APPLICATIONS

This application claims priority to U.S. provisional patent application number 63/791,003 filed Apr. 18, 2025, the entire disclosure of which is incorporated herein by reference.

### FIELD OF THE INVENTION

The present disclosure generally relates to a control system and method, and more particularly to a system and method for controlling an adult toy.

### BACKGROUND OF THE INVENTION

Interactive live-streaming platforms have become a popular medium for content creators (often referred to as models) to engage with their audience. To enhance engagement and interactivity, these platforms may integrate the capability for viewers to trigger effects on devices controlled by or associated with the model, such as controllable adult toys.

In such systems, low-latency and reliable transmission of control instructions from the point of interaction initiation (e.g., by a viewer) to the target device (e.g., the model's adult toy) provides for a satisfactory and immersive user experience. Delays or instability in the control loop can significantly diminish the responsiveness and perceived connection between the viewer's action and the resulting effect.

Conventional techniques for transmitting control instructions in these environments often face challenges related to transmission path complexity. Control instructions generated in response to viewer interactions typically traverse multiple segments within the live-streaming ecosystem before reaching the target device. Depending on the specific implementation, this transmission path may involve crossing public networks or intermediary systems between different functional components. While functional, such multi-segment communication paths are susceptible to inherent latency arising from network hops, potential congestion over wide-area networks, and use of intermediate systems, which can introduce points of failure.

Consequently, existing approaches may struggle to achieve the consistent low-latency and high-reliability transmission suitable for responsive control of peripherally connected devices, such as in time-sensitive, interactive scenarios like live adult entertainment.

### SUMMARY OF THE INVENTION

In one exemplary aspect, the present disclosure is directed to a method for controlling a sex toy of a model user. The method includes controlling a first control node to establish a communication connection with a livestreaming platform; generating a control instruction for the sex toy of the model user in response to an interactive event initiated by a viewer user of the livestreaming platform toward the model user; and controlling the first control node to obtain a network resource identifier of a second control node. The first control node and the second control node are both located within a same data transmission network, and the same data transmission network is configured to allow the first control node and the second control node to transmit data via peer-to-peer communication. The second control node establishes a communication link, which is wired or wireless, with a control module embedded in the sex toy of the model user. The method also includes controlling the first control node to establish a peer-to-peer communication data transmission link with the second control node based on the network resource identifier of the second control node; and controlling the first control node to send the control instruction to the second control node via the peer-to-peer communication data transmission link, so that the second control node forwards the control instruction to the control module embedded in the sex toy via the communication link, thereby controlling the sex toy to perform a sexual stimulation operation on the model user based on the control instruction.

In another aspect, the present disclosure is directed to a method for controlling a sex toy of a model user. The method includes controlling a first control node to obtain a network resource identifier of a second control node; wherein the first control node and the second control node are both located within a same data transmission network, and the same data transmission network is configured to allow the first control node and the second control node to transmit data via peer-to-peer communication; wherein the second control node establishes a communication link, which is wired or wireless, with a control module embedded in the sex toy of the model user; and wherein the first control node is an electronic communication device, and the second control node is configured as a WiFi communication module embedded in the sex toy, with the second control node and the control module of the sex toy integrated as a control system embedded within the sex toy. The method also includes controlling the first control node to establish a peer-to-peer communication data transmission link with the second control node based on the network resource identifier of the second control node; and controlling the first control node to forward a control instruction to the second control node via the peer-to-peer communication data transmission link, so that the second control node forwards the control instruction to the control module via the communication link, thereby controlling the sex toy to perform a sexual stimulation operation on the model user based on the control instruction.

### BRIEF DESCRIPTION OF THE DRAWINGS

FIG. 1 is a schematic illustration of an exemplary system of the present invention;

FIG. 2 is schematic illustration of exemplary accessories of the exemplary disclosed system;

FIG. 3 is a schematic illustration of an exemplary embodiment of the exemplary disclosed system;

FIG. 4 is a schematic illustration of an exemplary embodiment of the exemplary disclosed system;

FIG. 5 is a schematic illustration of an exemplary embodiment of the exemplary disclosed system;

FIG. 6 is a schematic illustration of an exemplary embodiment of the exemplary disclosed system;

FIG. 7 is a schematic flowchart illustration of an exemplary process of the exemplary embodiment illustrated in FIG. 6;

FIG. 8 is a schematic illustration of another exemplary embodiment of the exemplary disclosed system;

FIG. 9 is a schematic flowchart illustration of an exemplary process of the exemplary embodiment illustrated in FIG. 8;

FIG. 10 is a schematic illustration of an exemplary computing device, in accordance with at least some exemplary embodiments of the present disclosure; and

FIG. 11 is a schematic illustration of an exemplary network, in accordance with at least some exemplary embodiments of the present disclosure.

### DETAILED DESCRIPTION AND INDUSTRIAL APPLICABILITY

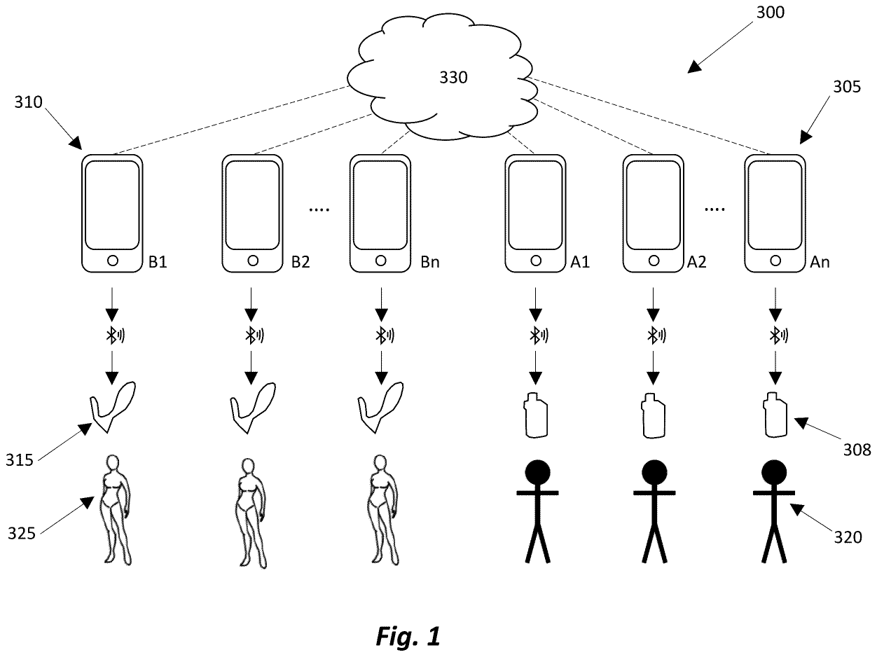

FIG. 1 illustrates an exemplary system 300 for providing a live broadcast (e.g., a livestream) including for example controlling devices such as adult devices (e.g., adult toys) as part of the live broadcast. For example, system 300 may include an online platform such as a live broadcast platform. In at least some exemplary embodiments, system 300 may be a system for providing the exemplary disclosed control method. In at least some exemplary embodiments, system 300 may provide an enhanced interactive viewing experience (e.g., between a given viewer and that viewer's device and/or adult toy; between a viewer and a livestreaming model; between a first viewer and a second viewer; or between a first viewer, a model, and a second viewer) across different live broadcast platforms (e.g., or any other suitable online entertainment for viewers accessed via a mobile app and/or other suitable applications that may run on the viewer's device). In at least some exemplary embodiments, system 300 may provide a toy control system with a point-to-point connection between devices such as a mobile device (e.g., mobile phone) and a computer (e.g., laptop or desktop computer) on a local area network of a livestreaming model. For example in at least some exemplary embodiments, control instructions for a livestreaming model's adult toy may be directly sent to the model's toy via the model's local area network (e.g., without being transferred through an external network). For example based on the exemplary disclosed configuration, a control delay for the model's adult toy may be reduced by system 300, and a control link may be relatively stable and reliable.

As illustrated in FIG. 1, system 300 may include one or more male user devices 305, one or more female user devices 310, one or more male accessories 308, and/or one or more female accessories 315. For example, system 300 may include a plurality of male user devices 305, a plurality of male accessories 308, a plurality of female user devices 310, and a plurality of female accessories 315. Data such as image data, audio data, and/or control data may be transferred between male user devices 305, male accessories 308, female user devices 310, and female accessories 315.

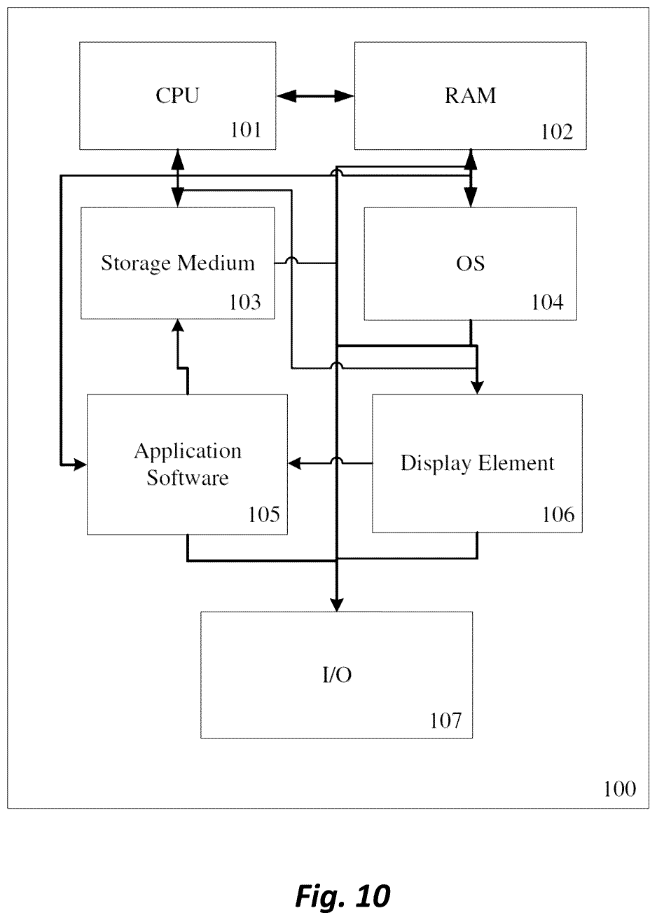

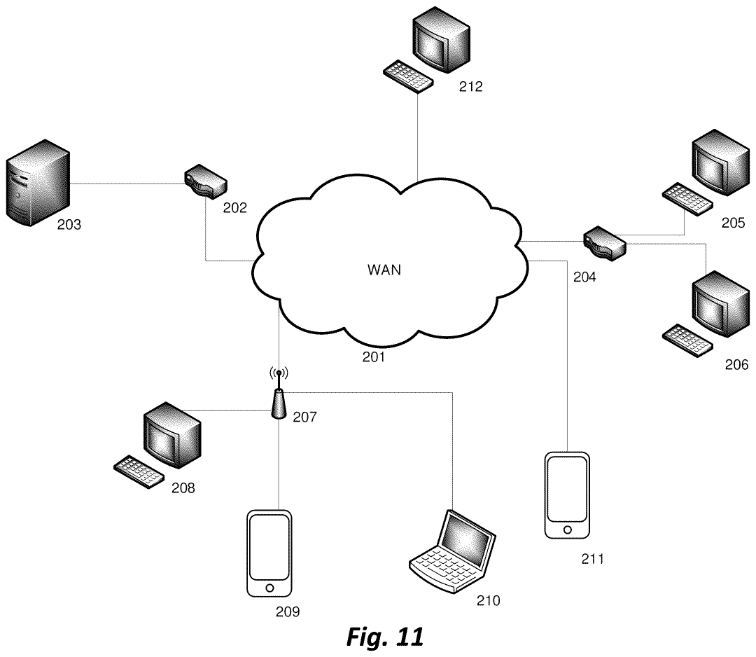

System 300 may include any desired number of male user devices 305 (e.g., A1, A2, . . . An). Male user device 305 may be any suitable device for interfacing with other components of system 300 such as a computing device (e.g., user interface). For example, male user device 305 may be any suitable user interface for receiving input and/or providing output (e.g., image data) to a male user 320. Male user device 305 may include a camera and a microphone. Male user device 305 may be, for example, a touchscreen device (e.g., of a smartphone, a tablet, a smartboard, and/or any suitable computer device), a wearable device, a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 10 and 11). For example, male user device 305 may include a touchscreen device of a smartphone or handheld tablet. For example, male user device 305 may include a display (e.g., a computing device display, a touchscreen display, and/or any other suitable type of display) that may provide output, image data, and/or any other desired output or input prompt to a user. For example, the exemplary display may include a graphical user interface to facilitate entry of input by a user and/or receiving output such as image data. An application for example as described herein and/or a web browser may be installed on male user device 305 and utilized by male user 320.

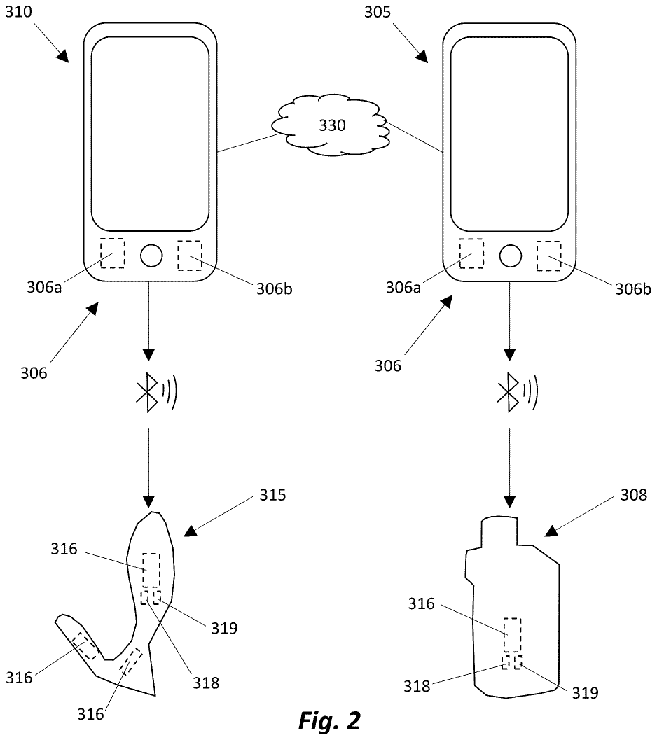

As illustrated in FIG. 2, male user device 305 may include a sensor array 306. In at least some exemplary embodiments, sensor array 306 may include one or more sensors integrated or built into the exemplary disclosed user device (e.g., male user device 305) such as, for example, a mobile phone, a pad, or a wearable device. Sensor array 306 may include any suitable sensors for use with system 300 such as, for example, a location sensor 306a and a movement sensor 306b. Location sensor 306a may include a GPS device, a Galileo device, a GLONASS device, an IRNSS device, a BeiDou device, and/or any other suitable device that may operate with a global navigation system.

Movement sensor 306b may include any suitable components for sensing motion (e.g., motion amplitude), velocity, and/or acceleration. Movement sensor 306b may include an acceleration sensor. Movement sensor 306b may include a gyroscope. For example, movement sensor 306b may include a displacement sensor, a velocity sensor, and/or an accelerometer. For example, movement sensor 306b may include components such as a servo accelerometer, a piezoelectric accelerometer, a potentiometric accelerometer, and/or a strain gauge accelerometer. Movement sensor 306b may include a piezoelectric velocity sensor or any other suitable type of velocity or acceleration sensor.

System 300 may include any desired number of female user devices 310 (e.g., B1, B2, . . . Bn). Female user device 310 may be similar to male user device 305. For example, female user device 310 may be any suitable user interface for receiving input and/or providing output (e.g., image data) to a female user 325. Female user 325 may operate female user device 310 to record and transfer image (e.g., video) and audio data to one or more male users 320 and/or other female users 325 via a network 330. Additional exemplary disclosed devices and/or users of any desired gender may also be included in the exemplary disclosed system (e.g., a non-binary user and/or a non-binary user device and/or non-binary accessory similar to the examples described herein).

Female accessory 315 may be any suitable accessory for use by female user 325 (e.g., when female user 325 is imaged by female user device 310). For example, female accessory 315 may be a prop that is used by female user 325 while female user 325 is being imaged (e.g., a video or pictures of female user 325 are being recorded and/or transmitted in real-time to be viewed by male user 320 and/or another female user 325). For example, female accessory 315 may be a device used for erotic stimulation (e.g., a sex aid or a “sex toy”). Female accessory 315 may be a sexual stimulation device that may be associated with a given female user 325 and respective female user device 310 of that given female user 325. In at least some exemplary embodiments, female accessory 315 may be a massaging apparatus for human genitalia (e.g., a vibrator). For example, female accessory 315 may be any suitable device for use in a video or pictures recorded by female user device 310, which may be an erotic video or erotic pictures). In at least some exemplary embodiments, female accessory 315 may be a tool or other indicator that may be used in video or pictures recorded by female user device 310 such as a sign providing information such as location or time information, a surveillance tool used by female user 325, and/or any other suitable tool or accessory that may be used while female user device 310 is recording a video or pictures of female user 325. For example, female user 325 may be an erotic model using female accessory 315 that may be an erotic device, a technician or laborer using female accessory 315 that may be a tool or work device specific to a desired application, and/or any other desired role using any suitable female accessory 315.

Female accessory 315 may include one or more driving components such as one or more motors 316. Motor 316 may include an electric motor. Motor 316 may include a servomotor, a stepper motor, a brushless motor, or any other suitable type of motor. Motor 316 may include any suitable vibration motor or haptic motor such as, for example, a mini vibrator motor. Motor 316 may include a low voltage motor. Motor 316 may include a pager motor or a coin vibration motor. Motor 316 may include a linear resonant actuator or an eccentric rotating mass vibration motor. Motor 316 may be a reversible electric motor (e.g., a reversible electric motor). Motor 316 may be a unidirectional motor (e.g., a one-way motor). Motor 316 may be powered by any suitable power source, such as a battery (e.g., a nickel-metal hydride battery, a lithium-ion battery, an ultracapacitor battery, a lead-acid battery, and/or a nickel cadmium battery), an electric power source (e.g., a transformer connected to a plug that may plug into an outlet), and/or any other suitable energy source. Female accessory 315 may include a controller 319 that may be any suitable computing device for controlling an operation of motor 316 and a communication device 318. Controller 319 may, for example, include components similar to the components described below regarding FIG. 10. Controller 319 may include for example a processor (e.g., micro-processing logic control device) or board components. Controller 319 may control one or more motors 316 based on input data and/or commands (e.g., control commands) received from male user device 305 and/or female user device 310 via a network 330 and/or communication device 318 (e.g., transferred directly to communication device 318 by any suitable component of system 300). Motor 316 may be controlled by controller 319 to vibrate female accessory 315 at a desired level or strength, perform a suction operation at a desired level or strength using female accessory 315 (e.g., using female accessory 315 as a suction device), rotate or swing female accessory 315 at a desired speed or amount, contract or expand female accessory 315 by a desired amount, cause female accessory 315 to perform an inhalation action, and/or cause female accessory 315 to perform any other suitable action or function.

In at least some exemplary embodiments, motor 316 may be or may include a thermal device such as a heater (e.g., or a cooler or any other suitable thermal device). Alternatively for example, a heater unit and the exemplary disclosed motor may be separately provided (e.g., installed) in the exemplary disclosed adult toy. In at least some exemplary embodiments, motor 316 may include an electric heating device such as an electric resistance heating device. Motor 316 may include a polyimide heater, a silicone rubber heater, and/or a resistive wire heater. Motor 316 may be controlled by controller 319 to heat or emit heat or warmth from female accessory 315. For example, motor 316 may cause a temperature variation of female accessory 315.

Returning to FIG. 2, male accessory 308 may include components generally similar to female accessory 315 and may operate generally similarly to female accessory 315. Male accessory 308 may be a sexual stimulation device that may be associated with a given male user 320 (e.g., a viewer of one or more female users 325 and/or male users 320; or a male model) and respective male user device 305 (e.g., a viewer device) of that given male user 320.

Network 330 may be any suitable communication network over which data may be transferred between one or more male user devices 305, one or more male accessories 308, one or more female user devices 310, and/or one or more female accessories 315. Network 330 may be the internet, a LAN (e.g., via Ethernet LAN), a WAN, a WiFi network, or any other suitable network. Network 330 may be similar to WAN 201 described below. The components of system 300 may also be directly connected (e.g., by wire, cable, USB connection, and/or any other suitable electro-mechanical connection) to each other and/or connected via network 330. For example, components of system 300 may wirelessly transmit data by any suitable technique such as, e.g., wirelessly transmitting data via 4G LTE networks (e.g., or 5G networks) or any other suitable data transmission technique for example via network communication. Components of system 300 may transfer data via the exemplary techniques described below regarding FIG. 11. Male user devices 305, male accessories 308, female user devices 310, and/or female accessories 315 may include any suitable communication components for communicating with other components of system 300 using for example the communication techniques described above. For example, male user devices 305 and female user devices 310 may include integrally formed communication devices (e.g., smartphone components), and male accessories 308 and female accessories 315 may each include communication device 318 that may communicate using any of the exemplary disclosed communication techniques.

In at least some exemplary embodiments, a given female accessory 315 may communicate with a given female user device 310 (e.g., a paired female user device 310) via any suitable short distance communication technique. For example, female accessories 315 (e.g., via communication device 318) and female user devices 310 may communicate via Wifi, Bluetooth, ZigBee, NFC, IrDA, and/or any other suitable short distance technique. Female accessory 315 may be an adult toy that may be connected with female user device 310 through short distance wireless communication. An application (e.g., operating using the exemplary disclosed modules) may be installed on female user device 310, the application and female user device 310 being configured to send commands to female accessory 315 to drive (e.g., actuate) female accessory 315. Male accessory 308 may communicate with male user device 305 similarly to the communication of female accessory 315 and female user device 310 described above.

System 300 may include one or modules for performing the exemplary disclosed operations such as, for example, the exemplary disclosed modules for example as described herein. The one or more modules may include an accessory control module for controlling male accessory 308 and female accessory 315. The one or more modules may be stored and operated by any suitable components of system 300 (e.g., including processor components) such as, for example, network 330, male user device 305, male accessory 308, female user device 310, female accessory 315, and/or any other suitable component of system 300. For example, system 300 may include one or more modules having computer-executable code stored in non-volatile memory. System 300 may also include one or more storages (e.g., buffer storages) that may include components similar to the exemplary disclosed computing device and network components described below regarding FIGS. 10 and 11. For example, the exemplary disclosed buffer storage may include components similar to the exemplary storage medium and RAM described below regarding FIG. 10. The exemplary disclosed buffer storage may be implemented in software and/or a fixed memory location in hardware of system 300. The exemplary disclosed buffer storage (e.g., a data buffer) may store data temporarily during an operation of system 300.

The one or more exemplary disclosed modules may include software modules running on model equipment. The software modules may include a smart panel (e.g., as described below), game plug-ins, and/or toy control plug-ins (e.g., for the exemplary disclosed toys) that may assist models in live broadcasting.

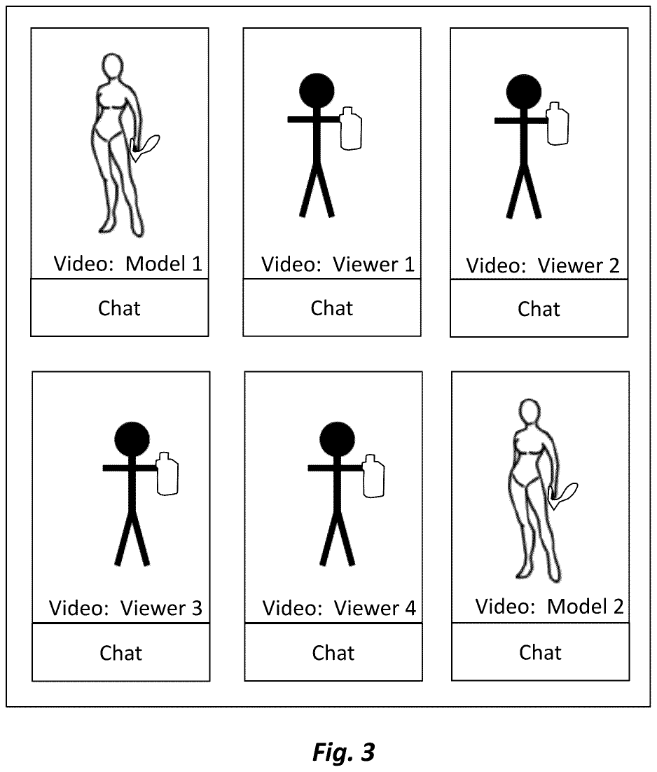

The one or more exemplary disclosed modules may also provide a chat room interface via one or more male user devices 305 and/or one or more female user devices 310 for use by male users 320 and female users 325. For example, video display of female user 325, one or more male users 320, and/or and a chat or messaging app (e.g., any suitable chat communication or messaging app such as, for example, text, voice, and/or video chat boxes) may be displayed to each male user 320 via male user device 305 and to each female user 325 via female user device 310. One or more male users 320 and one or more female users 325 may thereby view and chat (e.g., text, voice, and/or video chat) with each other via the one or more exemplary disclosed modules via respective male user devices 305 and female user devices 310. Male users 320 and female users 325 may thereby view, interact with, and/or chat (e.g., text, voice, and/or video chat) with other female users 325 and/or other male users 320 (e.g., and/or any other users of an gender such as non-binary users as described above or any other gender). For example, multiple text, voice, and/or video chat boxes including a plurality of male users 320 (e.g., viewers or models each having one or more male accessories 308) and/or a plurality of female users 325 (e.g., viewers or models each having one or more female accessories 315) may be displayed to each male user 320 and each female user 325 via respective male user devices 305 and female user devices 310. Male users 320 and female users 325 may thereby view and interact with other male users 320 and female users 325 that may each have one or more respective accessories (e.g., respective male accessories 308 and female accessories 315). FIG. 3 schematically illustrates an exemplary embodiment of the exemplary disclosed chat room that may be displayed to male user 320 via male user device 305 and/or to female user 325 via female user device 310.

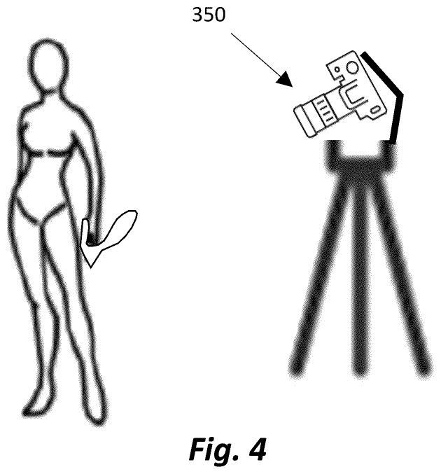

In at least some exemplary embodiments and as illustrated in FIG. 4, system 300 may further include an imaging device 350. Imaging device 350 may be used directly and/or indirectly to provide data to be used in an operation of system 300. For example, imaging device 350 may be a camera that may be used to obtain user input (e.g., data of gesturing images made by the user) by any suitable imaging technique (e.g., for example as described herein).

Imaging device 350 may be any suitable imaging device such as a camera. For example, imaging device 350 may be any suitable video camera such as a digital video camera, a webcam, and/or any other suitable camera for recording visual data (e.g., recording a video or taking pictures) and/or image recognition. Imaging device 350 may be a 3D camera. Imaging device 350 may be a headset that may be worn by a user (e.g., male user 320 or female user 325). Imaging device 350 may be a spatial computing device (e.g., a spatial computer). Imaging device 350 may utilize any suitable spatial computing features and/or techniques (e.g., similar to Apple Vision Pro). Imaging device 350 may be for example a three-dimensional video sensor or camera. One or more imaging devices 350 may include a plurality of cameras or a single camera configured to collect three-dimensional image data. In at least some exemplary embodiments, imaging device 350 may be a stereoscopic camera and/or any other suitable device for stereo photography, stereo videography, and/or stereoscopic vision. Imaging device 350 may be substantially entirely integrated into the exemplary disclosed user devices or may be a stand-alone device. In at least some exemplary embodiments, imaging device 350 may be a smartphone or tablet camera. Imaging device 350 may provide data to an exemplary image recognition module of system 300. Imaging device 350 may include one or more actuators that may adjust a position of imaging device 350 based on an operation of system 300 (imaging device 350 may also include a support or stand for supporting imaging device 350). The actuators may be for example one or more external actuators disposed at an exterior of imaging device 350 and/or one or more integrated actuators that are completely or partially integrated into imaging device 350 (e.g., disposed and/or integrated within an interior of imaging device 350). In at least some exemplary embodiments, the actuators may be internally integrated into imaging device 350 and may turn optical components and/or move lenses of imaging device 350 within a housing of imaging device 350 to zoom in and out at different features or points within a variable field of view of imaging device 350 (e.g., zoom in and out on points or features of a user and/or exemplary disclosed accessories). The actuator may also be one or more external and/or internally-integrated mechanical actuators configured to mechanically turn imaging device 350 and move lenses of imaging device 350 to focus in and out at desired objects (e.g., points and/or features of a user and/or an accessory). System 300 may also include an image recognition module that may perform feature detection and matching to allow for matching and comparison of features imaged by imaging device 350. For example, imaging device 350 may find predetermined features that may correspond to two-dimensional and/or three-dimensional surfaces and/or contours of an object within a field of view of imaging device 350. Also for example, any suitable technique may be used to identify features (e.g., spatial data) of a viewed object (e.g., features of a user and/or accessory) and to match those imaged features to predetermined features provided by system 300 (e.g., or provided by a user). Also for example, optical character recognition of text and/or markings located on a viewed object may be performed. For example, spatial data and/or other data may be determined that may be matched to predetermined data provided by system 300 (e.g., predetermined shapes, colors, text, contours, and other features). For example, the spatial data and/or other data may include data defining points (e.g., or contours) of a user and/or accessory based on an actual image of an object (e.g., the exemplary disclosed accessories) imaged by imaging device 350. For example, spatial and/or data based on viewing an object may be used to match that data to predetermined data to identify points or features of an object being viewed. Any suitable techniques for recognizing objects and/or determining spatial and/or other data of a viewed object may be utilized by system 300 for image recognition via imaging device 350.

The exemplary disclosed system and method may be used in any suitable application for controlling a device such as an adult toy during livestreaming. For example, the exemplary disclosed system and method may be used in any suitable application for controlling an adult toy based on tipping during a livestream broadcast. The exemplary disclosed system and method may be used in any suitable application involving controlling an adult device while livestreaming content is created by a user such as a model.

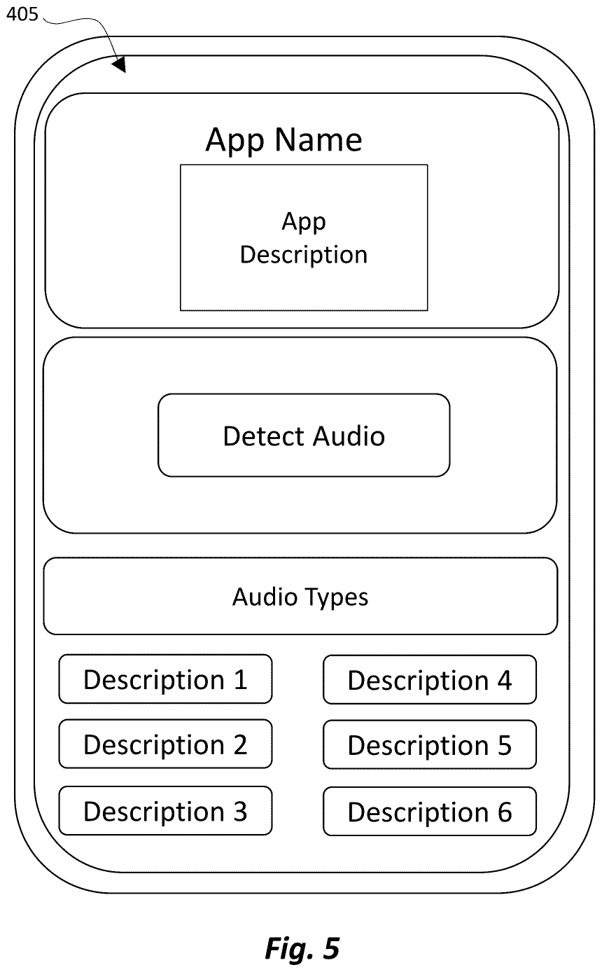

In at least some exemplary embodiments and for example as illustrated in FIG. 5, graphical elements provided by system 300 may be displayed on a graphical user interface such as a GUI 405 on a display or touchscreen of the exemplary disclosed user device (e.g., male user device 305, female user device 310, and/or any other suitable user device) to the user (e.g., or a spatial computing interface such as for example similar to Apple Vision Pro). Any suitable graphical element (e.g., text, graphics, GIFs, video, and/or any other suitable graphics) may be displayed on GUI 405. GUI 405 may display the exemplary disclosed live broadcast and/or data and/or elements associated with the live broadcast (e.g., input data, output data, control elements, graphical elements, information, and/or any other suitable data and/or objects) to one or more viewers and/or models (e.g., one or more female users 325 and/or male users 320) via one or more exemplary disclosed user devices (e.g., one or more female user devices 310 and/or one or more male user devices 305, and/or any other suitable device).

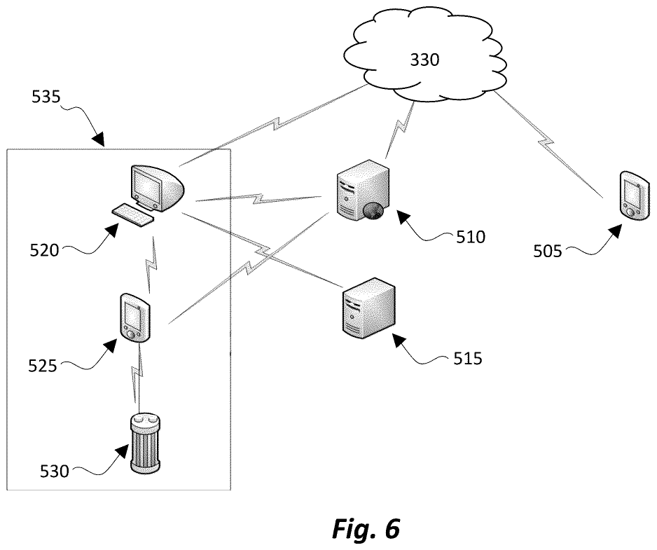

FIG. 6 illustrates another exemplary embodiment of the exemplary disclosed system. A viewer device 505 may be generally similar to male user device 305 or female user device 310 described above. A platform server 510 and a DNS server 515 may be generally similar to the exemplary disclosed servers described herein (e.g., regarding FIGS. 10 and 11). A model computer 520 may be generally similar to the exemplary disclosed computing devices (e.g., computers) described herein (e.g., regarding FIGS. 10 and 11). A model device 525 may be generally similar to male user device 305 or female user device 310 described above. A model accessory 530 may be generally similar to male accessory 308 or female accessory 315 described above. A LAN 535 (e.g., local area network) may be generally similar to the exemplary disclosed networks described herein (e.g., regarding FIG. 11). Model computer 520, model device 525, and/or model accessory 530 may be electronic communication devices. LAN 535 may connect (e.g., provide for communication between) model computer 520, model device 525, and/or model accessory 530 (e.g., any of model computer 520, model device 525, and model accessory 530 may communicate with each other via LAN 535).

In at least some exemplary embodiments and for example as illustrated in FIG. 6, the model's computer livestreaming function module may determine (e.g., determine by crawling) a tip (e.g., of a reward provided by viewers). A point-to-point connection may be established between the model's computer (e.g., model computer 520) and the model's device (e.g., model device 525 such as a mobile phone).

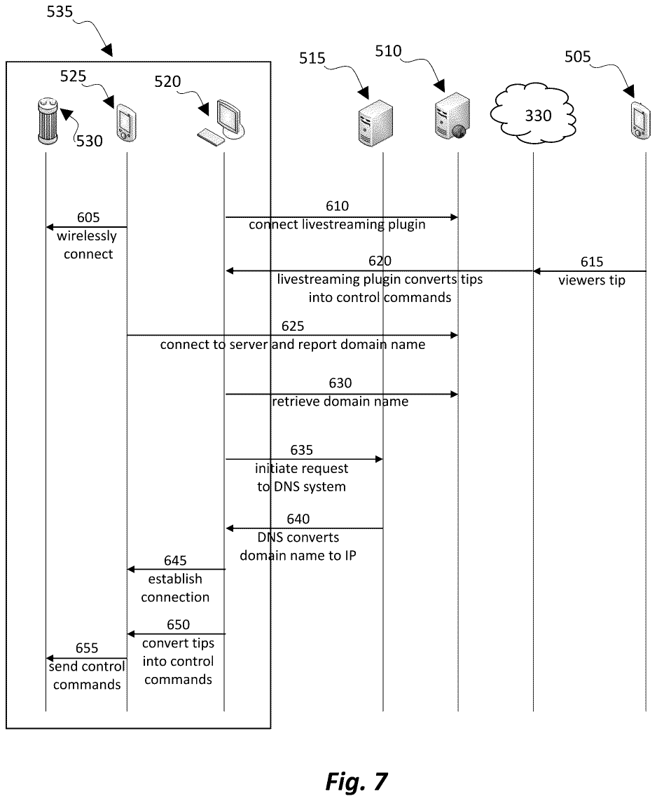

In at least some exemplary embodiments and as illustrated in FIGS. 6 and 7, the system architecture of the exemplary disclosed system (e.g., for a controllable sex toy) may include model computer 520, model device 525 (e.g., a model's mobile phone), and model accessory 530 (e.g., a sex toy of the model). Model computer 520 and model device 525 may be in communication with platform server 510 (e.g., a server of an application and/or platform provider), and any suitable communication connection may be established between model device 525 and model accessory 530. The exemplary disclosed communication connection may be a wireless or a wired connection (e.g., a Bluetooth connection, a WiFi connection, a data cable connection, and/or a connection provided by any suitable communication technique for example as described herein). Both model computer 520 and model device 525 may be located within a same local area network (e.g., LAN 535).

In at least some exemplary embodiments and as illustrated in FIG. 6, viewers (e.g., one or more male users 320 and/or female users 325) may use respective viewer devices 505 to reward models with tokens (e.g., or any other suitable units of value such as cryptocurrency or any other suitable units of monetary or financial value) on the exemplary disclosed livestreaming platform. A livestreaming plugin may be installed on model computer 520, which may be used to process (e.g., crawl) audience reward tokens and convert the token data into toy control commands. Also for example, model computer 520 may be used to retrieve the mobile domain name from platform server 510. Model computer 520 may also be used to resolve the mobile domain name into an IP address by communication with DNS server 515, and return the data of the IP address to model computer 520. Model device 525 (e.g., a mobile phone) may be used to map an IP address to a domain name and to send the domain name to platform server 510. A point-to-point connection between model computer 520 and model device 525 may be established. An application for connecting with model accessory 530 (e.g., a connecting application) may be installed on model device 525. Control instructions may be sent from model device 525 to model accessory 530 via the exemplary disclosed connecting application.

FIG. 7 illustrates an exemplary embodiment of a working process of the exemplary disclosed system architecture. At least some of the exemplary disclosed steps may be performed simultaneously. At step 605, model device 525 and model accessory 530 may connect (e.g., wirelessly connect). For example, model device 525 running the exemplary disclosed connecting application may wirelessly connect with one or more model accessories 530. At step 610, the exemplary disclosed livestreaming plugin may be connected. For example, the exemplary disclosed system may operate to connect the livestreaming plugin of model computer 520 to platform server 510.

At step 615, one or more viewers may tip the model via respective viewer devices 505. For example, viewers may use their respective viewer devices 505 (e.g., mobile phones) to reward models through the exemplary disclosed livestreaming platform based on viewer device 505 communicating with network 330. At step 620, the exemplary disclosed livestreaming plugin may convert tip data into control commands. For example, the livestreaming plugin installed on model computer 520 may process (e.g., e.g., obtain or identify by crawling) reward information (e.g., tips provided by viewers at step 615) and convert the rewards information into control commands for adult toys.

At step 625, model device 525 may connect via the exemplary disclosed connecting application to platform server 510 and provide (e.g., report) the mobile domain name of model device 525 to platform server 510. At step 630, model computer 520 may retrieve the mobile domain name. For example, model computer 520 may retrieve the mobile domain name of model device 525 from platform server 510. At step 635, model computer 520 may initiate a request to the DNS system (e.g., via DNS server 515). For example, model computer 520 may initiate a domain name resolution request for model device 525 to DNS server 515.

At step 640, the DNS system (e.g., via DNS server 515) may convert the domain to an IP address. For example, DNS server 515 may convert the domain name of model device 525 (e.g., the model's mobile phone, smart device, or any other suitable device for example as described herein) to an IP address and return the IP address to model computer 520. At step 645, model computer 520 may establish a connection with model device 525. For example, model computer 520 may establish a point-to-point connection with model device 525 via an internal network (e.g., LAN 535) based on the IP address of model device 525.

At step 650, the exemplary disclosed livestreaming plugin may convert tip data into control commands. For example, the livestreaming plugin installed on model computer 520 may convert the exemplary disclosed audience tip data (e.g., provided at step 615) into toy control commands and may send (e.g., transfer) the toy control commands to model device 525. At step 655, model device 525 may send the control commands to model accessory 530. For example, via the connecting application installed on model device 525, model device 525 may send the exemplary disclosed adult toy control commands to model accessory 530 (e.g., a sex toy of the model).

In at least some exemplary embodiments and as illustrated in FIGS. 6 and 7, model computer 520 and model device 525 may directly establish a point-to-point data communication connection within LAN 535. For example, model computer 520 may obtain the IP address of model device 525 within LAN 535 via any suitable method for example as described herein. Then model computer 520 may establish a point-to-point data communication connection with model device 525 within LAN 535 based on this IP address. The model (e.g., model user such as female user 325 or male user 320) may access the livestreaming platform through a browser provided on model computer 520 (e.g., and/or model device 525) and conduct a live performance for one or more viewer users (e.g., one or more male users 320 and/or female users 325) who may enter the model's live broadcast room on the livestreaming platform for example as described herein. The viewer users may reward the model user with the exemplary disclosed tips (e.g., tokens and/or any other suitable units of value for example as described herein) via the exemplary disclosed livestreaming platform.

In at least some exemplary embodiments and as illustrated in FIGS. 6 and 7, the exemplary disclosed plugin (e.g., livestreaming or browser plugin) installed on model computer 520 (e.g., and/or model device 525) may obtain (e.g., determine) the quantity (e.g., and/or any other suitable characteristics) of these tokens, and then this plugin may generate corresponding sex toy control instructions based on the quantity of these tokens. For example, the exemplary disclosed plugin may be preconfigured with a mapping relationship between the token quantity and the sex toy control instructions, and corresponding sex toy control instructions may be generated by the exemplary disclosed system based on the obtained token quantity according to this mapping relationship. The plugin installed on model computer 520 may send the exemplary disclosed sex toy control instructions directly to model device 525. An application program (e.g., the exemplary disclosed connecting application) configured to manage the connection and control of model accessory 530 (e.g., a sex toy) may be installed on model device 525. For example, the exemplary disclosed connecting application may be configured to manage the communication connection and data transmission between model device 525 and model computer 520. The connecting application may forward the received sex toy control instructions to model accessory 530 of the model via model device 525. Model accessory 530 may be controlled based on the sex toy control instructions (e.g., to perform sexual stimulation operations on the model user).

The IP address of model device 525 may be obtained via any suitable method. For example as a first method, a mapping table may be utilized. The exemplary disclosed mapping table may be configured to maintain a mapping relationship between the IP address of model device 525 and the domain name of model device 525, which may be established in advance via DNS server 515 (e.g., a target DNS server). Model computer 520 and model device 525 may be in communication (e.g., be connected) with platform server 510. Platform server 510 may obtain login account information of model computer 520 and the login account information of model device 525. Platform server 510 may determine that model computer 520 and model device 525 belong to the same model user based on the obtained login account information. Then platform server 510 may determine that the model's model computer 520 is to establish a communication connection with this model's model device 525. Because this model's model device 525 may have the domain name of the model's model device 525 uploaded by the model's model device 525 (e.g., including communication information such as the IP address of the model's model device 525 such as a mobile phone plus the port of the model's mobile phone) when establishing a communication connection with platform server 510 (e.g., after the livestreaming or browser plugin of the model's model computer 520 obtains the IP address of the model's model device 525), the exemplary disclosed plugin of the model's model computer 520 may find the domain name (e.g., the domain name of the model's model device 525 from platform server 510). Then, the exemplary disclosed plugin of the model's model computer 520 may send a domain name resolution request for the domain name of the model's model device 525 to DNS server 515. DNS server 515 may perform domain name resolution on the domain name of the model's model device 525 based on this domain name resolution request to obtain the IP address of the model's model device 525 (e.g., mobile phone or any other suitable user device for example as described herein). DNS server 515 may return the resolved IP address of the model's model device 525 to the exemplary disclosed plugin of the model's model computer 520. The exemplary disclosed plugin of the model's model computer 520 may control the model's model computer 520 to establish a point-to-point data communication connection (e.g., which can be a wireless connection such as a WiFi connection or any other suitable connection for example as described herein) with the model's model device 525 within LAN 535 based on the IP address of the model's model device 525.

For example as a second method of obtaining the IP address of model device 525, the IP address may be directly entered by the model user. For example, the model user may directly enter the IP address of model device 525 on an operation page (e.g., via GUI 405) configured by the exemplary disclosed livestreaming or browser plugin of model computer 520 (e.g., and/or model device 525).

After obtaining the IP address of model device 525 via any suitable method, the exemplary disclosed system may operate to cache the IP address. For example, when the livestreaming or browser plugin of a model's model computer 520 (e.g., and/or model device 525) obtains the IP address of the model's model device 525, the IP address of the model's model device 525 may be cached or saved locally on the model's model computer 520. Because model computer 520 and model device 525 within the same local area network (e.g., LAN 535) may directly establish a point-to-point data communication connection within the local area network, the sex toy control instructions generated by the exemplary disclosed plugin on model computer 520 may be directly sent to the model's model device 525, and then sent by the model's model device 525 to the model's model accessory 530 (e.g., sex toy for the model). Accordingly for example, the control delay of the sex toy for the model may be decreased and a stability and reliability of the control link may be increased.

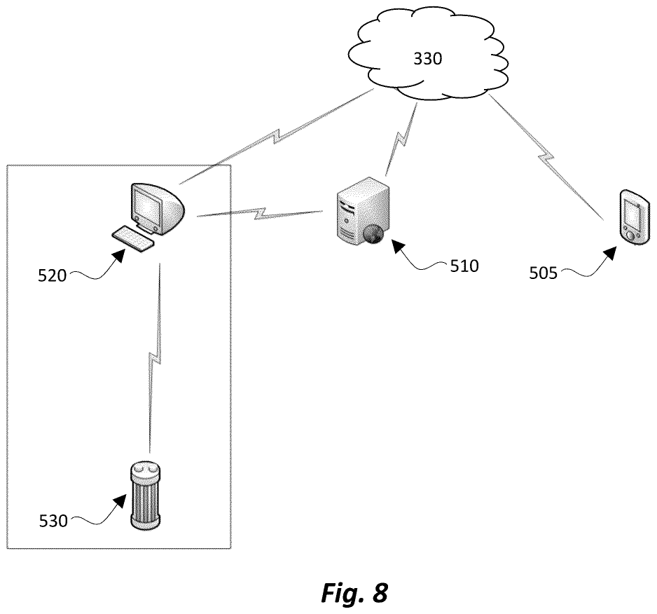

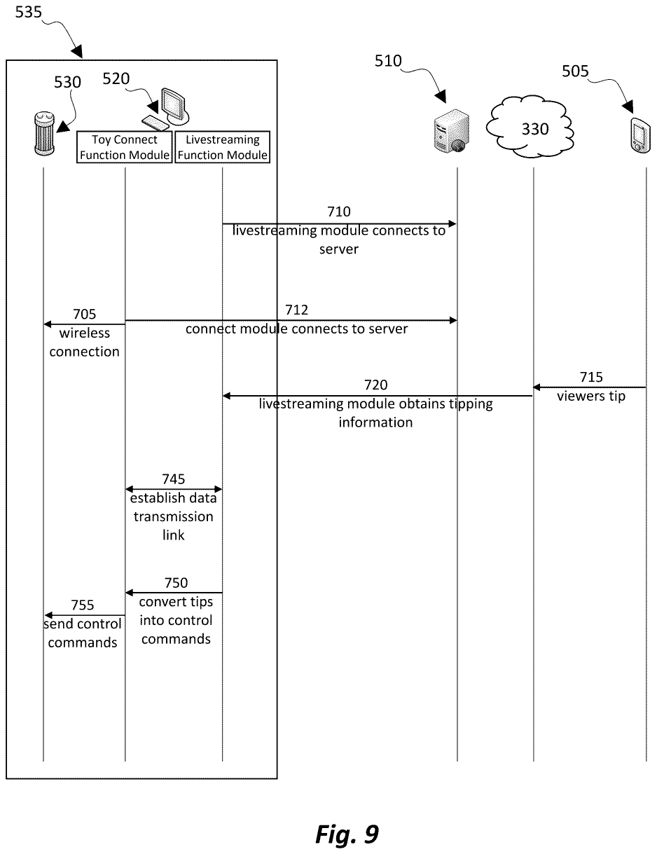

FIGS. 8 and 9 illustrate another exemplary embodiment of the exemplary disclosed system in which a streaming module (e.g., livestreaming function module) and a connect module (e.g., toy connect function module) may be integrated with model computer 520. The streaming module (e.g., livestreaming function module) and the connect module (e.g., toy connect function module) may be generally similar to the exemplary disclosed modules described herein. Model accessory 530 may be directly connected to model computer 520. The streaming module (e.g., livestreaming function module) may convert token data into adult toy control commands and send them to the connect module (e.g., toy connect function module), which may send the control commands to model accessory 530.

FIG. 9 illustrates an exemplary embodiment of a working process of the exemplary disclosed system architecture. At least some of the exemplary disclosed steps may be performed simultaneously. At step 705, the toy connect function module of model computer 520 and one or more model accessories 530 may connect (e.g., wirelessly connect). At step 710, the livestreaming function module of model computer 520 may connect to platform server 510. At step 712, the toy connect function module of model computer 520 may connect to platform server 510. At step 715, one or more viewers may tip the model via respective viewer devices 505. For example, viewers may use their respective viewer devices 505 (e.g., mobile phones) to reward models through the exemplary disclosed livestreaming platform based on viewer device 505 communicating with network 330. At step 720, the livestreaming function module of model computer 520 may obtain tipping information and convert tip data into control commands (e.g., which may also be performed at step 750). For example, the livestreaming function module of model computer 520 may process (e.g., e.g., obtain or identify by crawling) reward information (e.g., tips provided by viewers at step 715) and convert the rewards information into control commands for adult toys (e.g., this may also be performed at step 750). At step 745, a data transmission link may be established between the toy connect function module and the livestreaming function module of model computer 520.

At step 750, the livestreaming function module of model computer 520 may convert tip data into control commands. For example, the livestreaming function module of model computer 520 may convert the exemplary disclosed audience tip data (e.g., provided at step 715) into toy control commands and may send (e.g., transfer) the toy control commands to the toy connect function module of model computer 520. At step 755, the toy connect function module of model computer 520 may send the control commands to model accessory 530.

In at least some exemplary embodiments and as illustrated in FIGS. 8 and 9, the livestreaming function module and the toy connect function module may be integrated into model computer 520. The model may use the exemplary disclosed livestreaming or browser plugin (e.g., of the livestreaming function module) installed on the model's model computer 520 (e.g., and/or model device 525) to conduct a live broadcast. The model's model accessory 530 (e.g., sex toy) may include a built-in WiFi module (e.g., that may be generally similar to the exemplary disclosed modules described herein) and may operate in an access point (AP) mode. The model's model computer 520 may directly connect to model accessory 530 via WiFi to form an independent communication network, and model computer 520 may establish a communication connection with the target server (e.g., platform server 510 and/or network 330).

In at least some exemplary embodiments and as illustrated in FIGS. 8 and 9, a network connection may be established. After the toy connect function module of model computer 520 is initiated, the toy connect function module may search for model accessory 530 (e.g., one or more sex toy devices of the model) within LAN 535 by sending SSDP broadcast packets. The WiFi module of model accessory 530 may respond and return an XML description file that includes device information (e.g., including the device name, the supported protocol version, and any other suitable device information for example of model accessory 530). Any suitable technique such as using WiFi Direct technology may be utilized to establish the connection. Model computer 520 may initiate a connection request to model accessory 530, and the pairing may be completed through WSC protocol (e.g., entering a PIN code). The model user may set (e.g., provide or complete) the relevant settings via model computer 520 to allow for the toy connect function module of model computer 520 to establish a communication connection with the exemplary disclosed built-in WiFi module of model accessory 530.

In at least some exemplary embodiments and as illustrated in FIGS. 8 and 9, data communication may be established between the livestreaming function module and the toy connect function module of model computer 520. The livestreaming function module of model computer 520 may determine (e.g., obtain) a software port of the toy connect function module, and then a data transmission link may be established between the livestreaming function module and the toy connect function module of model computer 520. After the livestreaming function module processes (e.g., crawls) the exemplary disclosed reward information of the viewers (e.g., tips provided at step 715) on the livestreaming platform (e.g., via network 330) and converts the tip information into toy control instructions, the livestreaming function module may send the toy control instructions to the toy connect function module through the exemplary disclosed data transmission link. The toy connect function module may forward the toy control instructions to model accessory 530 (e.g., the sex toy).

In at least some exemplary embodiments, the exemplary disclosed system architecture of the controllable sex toy (e.g., model accessory 530) may include a first control node (e.g., first functional entity) such as, for example, model computer 520 (e.g., that may include the livestreaming function module and the toy connect function module), model device 525, and/or the exemplary disclosed livestreaming or browser plugin of model computer 520 (e.g., and/or model device 525). For example, the exemplary disclosed first control node (e.g., the first functional entity) may include the exemplary disclosed model computer (e.g., model computer 520) or the exemplary disclosed livestreaming software program. The exemplary disclosed system architecture of the controllable sex toy (e.g., model accessory 530) may also include a second control node (e.g., a second functional entity) such as, for example, model device 525, the exemplary disclosed built-in control module of model accessory 530, and/or a toy control plugin installed on the model's terminal device (e.g., model computer 520). The exemplary disclosed system architecture may also include a server (e.g., platform server 510) and a sex toy (e.g., model accessory 530).

The first control node (e.g., first functional entity) may interact with the exemplary disclosed livestreaming platform (e.g., via network 330) and receive interaction events (e.g., the exemplary disclosed tips or rewards) of the viewers. The first control node (e.g., first functional entity) may generate control instructions and may be internally configured to have a mapping relationship (e.g., mapping relationship data) between the interaction events and the sex toy control instructions. The first control node (e.g., first functional entity) may also obtain the network resource indicator (e.g., an IP address or the port of one of the exemplary disclosed software function modules) of the second control node (e.g., the second functional entity) to establish a communication connection with the second control node (e.g., the second functional entity).

The second control node (e.g., the second functional entity) may be included in the same data transmission network (e.g., a local area network such as LAN 535) as the first control node (e.g., first functional entity) and may perform point-to-point data communication with the first control node (e.g., first functional entity). The second control node (e.g., the second functional entity) may establish a wired or wireless communication link (e.g., a Bluetooth, WiFi, data cable connection, or any other suitable communication link for example as described herein) with the exemplary disclosed control module of the sex toy (e.g., model accessory 530) and may forward the received control instructions to the sex toy.

The exemplary disclosed server (e.g., platform server 510) may communicate (e.g., via communication connections) with both the first control node (e.g., first functional entity) and the second control node (e.g., the second functional entity). The exemplary disclosed server may store user information and verify whether the first control node (e.g., first functional entity) and the second control node (e.g., the second functional entity) belong to the same user. In at least some exemplary embodiments, the exemplary disclosed server may also generate sex toy control instructions according to preset rules and send them to the second control node (e.g., the second functional entity).

The exemplary disclosed sex toy (e.g., model accessory 530) may include a built-in control module, which may receive the control instructions forwarded by the second control node (e.g., the second functional entity) and may perform sexual stimulation operations on the model user according to the control instructions.

In at least some exemplary disclosed embodiments, the exemplary disclosed system architecture may follow the following exemplary working process. First, the system may operate to obtain a network resource indicator of the exemplary disclosed second functional entity. The exemplary disclosed first functional entity may obtain the network resource indicator (e.g., which may be an IP address, the port of a software function module, or a domain name, or any other suitable indicator) of the second functional entity for example in through one of the following techniques. Network resolution method (e.g., may be applicable when the network resource indicator is an IP address) may be utilized. The first functional entity and the second functional entity may each respectively establish a communication connection with the exemplary disclosed server and may upload user identification information to the server. The server may verify the user identification information of the two, confirm that they belong to the same user, and establish an association. When the second functional entity connects to the server, it may upload its own network identification information (e.g., the domain name and the corresponding IP address). When the first functional entity obtains the IP address of the second functional entity, the first functional entity may query the domain name of the second functional entity from the server. After the first functional entity obtains the domain name, it may send a domain name resolution request to the DNS server (e.g., for example as described above regarding FIGS. 6 and 7). The DNS server may perform a resolution according to the exemplary disclosed domain name-IP address mapping relationship that it may maintain and may return the resolved IP address to the first functional entity. The first functional entity may cache the obtained IP address locally for subsequent use. Alternatively, a manual input method may be used. The user may manually enter the network resource indicator (e.g., the IP address or the port of a software function module) of the second functional entity on the operation interface of the first functional entity. After the input is completed, the first functional entity may save the input data. Also as an alternative, a software module self-identification method (e.g., may be applicable when the network resource indicator is the port of a software function module) may be used. If the first functional entity and the second functional entity are different software function modules on the same device (e.g., the live streaming plugin and the toy control plugin on the model's terminal device such as model computer 520 or model device 525), the first functional entity and the second functional entity may operate to identify the software module port of the other party (e.g., via the software mechanism inside of the device) and may establish a communication connection.

Secondly in the exemplary working process, a point-to-point communication link may be established. The first functional entity may establish a point-to-point data communication link with the second functional entity within the same data transmission network (e.g., LAN 535) based on the obtained network resource indicator of the second functional entity. If the network resource indicator is for example an IP address, a connection may be established through a network protocol (e.g., TCP/IP). If the network resource indicator is for example a port of a software function module, a connection may be established through the software communication interface inside the device.

Thirdly in the exemplary working process, livestreaming interaction and instruction generation may be performed. The user (e.g., model user) may access the livestreaming platform through the first functional entity and may conduct a livestreaming performance. The viewers may interact with the host on the livestreaming platform, for example, by performing a reward operation (e.g., exemplary disclosed tipping). The first functional entity may monitor the interaction events of the viewers in real time and may generate sex toy control instructions according to the exemplary disclosed preset mapping relationship. Alternatively for example, the first functional entity may send the interaction event information of the viewers to the server, and the server may generate sex toy control instructions according to preset rules (e.g., of the exemplary disclosed mapping) and send the instructions to the second functional entity.

Fourthly in the exemplary working process, instruction transmission and toy control may be performed. The first functional entity may send the generated control instructions to the second functional entity through the established point-to-point communication link. After receiving the control instructions, the second functional entity may forward the instructions to the control module of the sex toy through the communication link established with the sex toy. The control module of the sex toy may parse the content of the instructions and perform sexual stimulation operations on the user (e.g., model user) according to the criteria of the instructions.

In at least some exemplary disclosed embodiments, if the exemplary disclosed point-to-point communication between the first functional entity and the second functional entity fails, the server may directly send the control instructions to the second functional entity to substantially ensure that the sex toy may continue to receive and execute the instructions. Based on the above exemplary disclosed system architecture and working process, by using the exemplary disclosed point-to-point communication between the first functional entity and the second functional entity within the same data transmission network (e.g., LAN 535), an efficient and stable transmission of the sex toy control instructions may be provided (e.g., realized), thereby achieving low-latency and relatively reliable control of the sex toy.

In at least some exemplary disclosed embodiments, the exemplary disclosed system architecture of the controllable sex toy may include a model's computer (e.g., model computer 520), a model's mobile phone (e.g., model device 525 that may be a mobile phone or any other suitable device for example as described herein), and a sex toy (e.g., model accessory 530) for the model. Among them, the model's computer and the model's mobile phone may be in communication (e.g., via communication connection) with the platform server (e.g., platform server 510), and a wireless or wired connection (e.g., a Bluetooth connection, a WiFi connection, a data cable connection, of other exemplary disclosed connection) may be established between the model's mobile phone and the sex toy for the model. Both the model's computer and the model's mobile phone may be located within the same local area network (e.g., LAN 535). An exemplary embodiment of the working process of this exemplary disclosed system architecture is described below.

In the exemplary embodiment of the working process, the model's computer (e.g., model computer 520) and the model's mobile phone (e.g., model device 525 that may be a mobile phone or any other suitable device for example as described herein) may directly establish a point-to-point data communication connection within the local area network (e.g., LAN 535). For example, the model's computer may obtain the IP address of the model's mobile phone within this local area network through various methods as described herein, and then the model's computer may establish a point-to-point data communication connection with the model's mobile phone within this local area network based on the IP address.

Further in the exemplary embodiment of the working process, the model user may access the livestreaming platform (e.g., via network 330) through the exemplary disclosed browser on the model's computer and may conduct a live performance for one or more viewer users who may enter the model's live broadcast room on the livestreaming platform (e.g., via network 330). The viewer users may reward the model user with tokens through the live streaming platform for example as described herein. The exemplary disclosed browser plugin installed on the model's computer may obtain a quantity of these tokens, and then this browser plugin may generate corresponding sex toy control instructions based on the quantity of these tokens. For example, the browser plugin may be preconfigured with a mapping relationship between the token quantity and the sex toy control instructions, and corresponding sex toy control instructions may be generated based on the obtained token quantity according to this mapping relationship. The browser plugin of the model's computer may send the sex toy control instructions directly to the model's mobile phone.

Further in the exemplary embodiment of the working process, an application may be installed on the model's mobile phone (e.g., as described above), and the application may be used to manage the connection and control of the sex toy. For example, the application (e.g., application program for example as described herein) may also be configured to manage the communication connection and data transmission between the model's mobile phone and the model's computer. This application program may forward the received sex toy control instructions to the sex toy for the model through the model's mobile phone. The sex toy for the model may control the sex toy for the model to perform sexual stimulation operations on the model user based on these sex toy control instructions.

In at least some exemplary disclosed embodiments, because the model's computer (e.g., model computer 520) and the model's mobile phone (e.g., model device 525 that may be a mobile phone or any other suitable device for example as described herein) within the same local area network (e.g., LAN 535) may directly establish a point-to-point data communication connection within the local area network, the sex toy control instructions generated by the browser plugin on the model's computer may be directly sent to the model's mobile phone, and then may be sent by the model's mobile phone to the sex toy for the model. Accordingly for example, the control delay of the sex toy for the model may be relatively low and a control link may be relatively stable and reliable.

In at least some exemplary disclosed embodiments, after the viewer user rewards the model user with tokens on the exemplary disclosed livestreaming platform, platform server 510 may also generate corresponding sex toy control instructions based on the quantity of these tokens. For example, platform server 510 may be preconfigured with a mapping relationship between the token quantity and the sex toy control instructions, and corresponding sex toy control instructions may be generated based on the obtained token quantity according to this mapping relationship. Then, platform server 510 may send these sex toy control instructions to the model's mobile phone (e.g., or any other suitable device for example as described herein) of the model user.

In at least some exemplary disclosed embodiments, the below described method may be used for obtaining the IP address of the model's device (e.g., model device 525 that may be a mobile phone or any other suitable device for example as described herein). A mapping table may be configured to maintain the exemplary disclosed mapping relationship between the IP address of the model's mobile phone. The domain name of the model's mobile phone may be established in advance in the target DNS server (e.g., DNS server 515). Among them, both the model's computer and the model's mobile phone may be in communication connection with the exemplary disclosed platform server (e.g., platform server 510). The platform server may obtain the login account information of the model's computer and the login account information of the model's mobile phone. The platform server may recognize or determine that this model's computer and this model's mobile phone belong to the same model user based on the obtained login account information. Then the platform server may recognize or determine that the model's computer is to establish a communication connection with this model's mobile phone. Because the model's mobile phone may recognize or determine the domain name of the model's mobile phone uploaded by the model's mobile phone (e.g., including communication information such as the IP address of the model's mobile phone plus the port of the model's mobile phone) when establishing a communication connection with the platform server (e.g., after the browser plugin of the model's computer is to recognize or determine the IP address of the model's mobile phone), the browser plugin of the model's computer may determine (e.g., find) the domain name of the model's mobile phone from the platform server. Then, the browser plugin of the model's computer may send a domain name resolution request for the domain name of the model's mobile phone to the DNS server. The DNS server may perform domain name resolution on the domain name of the model's mobile phone based on this domain name resolution request to obtain the IP address of the model's mobile phone. The DNS server may return the resolved IP address of the model's mobile phone to the browser plugin of the model's computer. The browser plugin of the model's computer may control the model's computer to establish a point-to-point data communication connection (e.g., which may be a wireless connection such as a WiFi connection) with the model's mobile phone within the local area network based on the IP address of the model's mobile phone.

In at least some exemplary disclosed embodiments, the below described method may alternatively be used for obtaining the IP address of the model's device (e.g., model device 525 that may be a mobile phone or any other suitable device for example as described herein). The model user may directly enter the IP address of the model's mobile phone on the operation page configured by the exemplary disclosed browser plugin of the model phone. Any suitable domain name form may be used (e.g., IP address numerals followed by domain name characters). When the exemplary disclosed browser plugin of the model's computer obtains the IP address of the model's mobile phone, the plugin may operate to cache or save the IP address of the model's mobile phone locally on the model's computer.

Another exemplary embodiment of the exemplary disclosed system and method follows, which involves a control scenario based on the model's computer and the model's mobile phone. The first functional entity may be the model's computer of the model user, and the second functional entity may be the mobile device (e.g., mobile phone) of the model user. A browser plugin, which may be configured to manage the communication connection and data transmission between the model's computer and the model's mobile phone, may be installed on the model's computer. The model user may also use this browser plugin to access the livestreaming platform on the model's computer, so that the model user may perform for one or more viewer users who enter the model user's live broadcast room on the livestreaming platform. For example, the model may set up a livestreaming environment in a home environment, using the model's computer (e.g., personal computer) as the first functional entity, and a model's mobile phone as the second functional entity. The sex toy may support remote control through a specific protocol. All three of the above may be connected to the home wireless network to form a local area network environment. A detailed working process of this scenario follows.

In the exemplary disclosed working process, a network connection may be established, which may involve entering an API configuration page in a developer management platform to configure application information. “Website Name” may be filled in, which may be displayed in the sex toy management application. The “Callback URL” may be set, which may be the address for the platform server to receive the status update information of the sex toy (e.g., the device connection status, instruction execution status, and any other suitable information). The “Heartbeat” may be configured to determine the time interval for the sex toy management application to send status updates to the platform server. For example, this may be set to send updates once every 30 seconds (e.g., or other suitable time periods) to substantially ensure that the platform server may obtain device status updates in a timely manner.

Further in the exemplary disclosed working process, connecting to the sex toy may be performed. After an intelligent model's mobile phone is turned on and connected to the local area network, the user may be guided to connect the sex toy through a Connect APP (e.g., iOS or Android). The user may first install the Connect APP on the device, and after opening the APP, may pair the sex toy with this application. At the same time, a developer on the model's computer side may obtain the connection QR code by calling a Server API. The API URL may be provided (e.g., using an HTTPS POST request). The request body may be in JSON format, which may contain suitable parameters: ‘token’ (the developer token, used for identity verification, may be provided), ‘uid’ (the user ID in the application, may be provided), ‘uname’ (the user name in the application, which may be optional), ‘utoken’ (the user token on the website, used for the developer to verify the user identity by themselves, which may be optional), and ‘v’ (the version number, may be provided). The JSON data provided by the platform server may contain the URL of the QR code image. The system may display this QR code to the user, and the user may scan the QR code with the Connect APP to complete the connection operation. After the connection is successful, the Connect APP may send a POST request to the “Callback URL” set by the developer in the management platform. The request body may contain the user ID, the user token, the application domain name, each port number (HTTP, HTTPS, WebSocket, and/or any other suitable ports), the platform type (iOS or Android), the application version, the protocol version, and/or the connected sex toy information (e.g., the toy ID, name, nickname, status, and/or other suitable data).

Further in the exemplary disclosed working process, a process of establishing the connection between the model's computer and the model's mobile phone may be performed. For example, IP address acquisition may be performed. A DNS resolution method may be used. After the intelligent model's mobile phone completes the connection with the sex toy and registers with the platform server, the platform server may verify that the model's computer and the model's mobile phone belong to the same user and may create a mapping relationship between the device IP address and the domain name in the DNS server. When the browser plugin on the model's computer is to obtain the IP address of the model's mobile phone, it may first query the domain name corresponding to the model's mobile phone from the platform server, and then send a domain name resolution request to the DNS server. After obtaining the IP address, it may cache it locally and set the cache validity period, and (e.g., at the same time) regularly detect the validity of the IP address by sending ICMP Echo requests.

Further in the exemplary disclosed working process, IP address acquisition may be performed. For example, a manual input method may be used. For example if the DNS resolution fails or the user chooses manual configuration, the IP address of the intelligent model's mobile phone may be manually entered in the settings interface of the browser plugin. After the input, the plugin may send a connection request to the specified port of this IP address to test the network reachability. If a response is received within the specified time, the IP address may be saved for subsequent communication.

Further in the exemplary disclosed working process, a connection may be established. For example, after the browser plugin of the model's computer obtains the IP address of the model's mobile phone, a connection may be established using the TCP protocol. The connection stability may be substantially ensured through the three-way handshake mechanism of the model's mobile phone (e.g., sending a SYN packet, receiving a SYN ACK packet, and sending an ACK packet). The system may provide for setting the initial window size, providing the delayed acknowledgment mechanism to reduce the number of ACK packets, and using the TCP “keep alive” mechanism (e.g., sending a probe packet at a certain interval) to maintain the long connection.

Further in the exemplary disclosed working process, livestreaming interaction and instruction generation may be performed (e.g., including livestreaming platform interaction). For example, the model may access the livestreaming platform through the browser of the model's computer to conduct a live broadcast, and the livestreaming data may be pushed using a protocol such as RTMP. When the viewers watch the live broadcast on the livestreaming platform, they can perform the exemplary disclosed token reward operations through the interface.

Further in the exemplary disclosed working process, an instruction generation mechanism may operate. For example, the browser plugin may monitor the reward events on the live streaming platform in real time and obtain the token quantity by interacting with the platform API. The plugin may have a dynamically configurable token-control instruction mapping table (e.g., that may be built-in) and may generate corresponding instructions according to different token quantity intervals. When generating instructions (e.g., if local APIs, which may be suitable for the same local area network environment, are used), a request may be constructed according to the corresponding API specification. For example, to obtain the sex toy information, an API URL (e.g., https://{domain}:{httpsPort}/command) may be used, using an HTTPS POST request. The request body may be in JSON format. The parameter ‘command’ may be set (e.g., to “GetToys”). For example, if a user wants to control the action of the sex toy, ‘command’ may be set to “Function”, and ‘action’ (such as “Vibrate:16” indicating vibration at intensity 16) may be set, ‘timeSec’ (the total running time) may be set, and/or any other suitable parameters suitable for use may be set. The instruction data may be encoded in the specified format, including suitable instruction information and a check field.

Further in the exemplary disclosed working process, instruction transmission and toy control may be performed (e.g., including transmission from the computer to the model's mobile phone). For example, the browser plugin may send the generated instructions to the intelligent model's mobile phone through the established TCP connection. In the transmission process, the Nagle algorithm may be used to reduce the number of small packets, and the sliding window protocol may be used for flow control to substantially ensure reliable data transmission.

Further in the exemplary disclosed working process, transmission from the model's mobile phone to the toy may be performed. For example, the Connect APP on the intelligent model's mobile phone may maintain a connection with the sex toy via Bluetooth. Based on the pairing relationship established between the APP and the sex toy, the APP may convert the received instructions into the protocol format (e.g., such as the ATT protocol characteristic value) recognizable by the sex toy and may send them. When sending instructions, relevant communication rules of the local APIs may be followed to substantially ensure accurate transmission of the instructions.

Further in the exemplary disclosed working process, toy execution of actions may be performed. For example, the sex toy may have a built-in control chip. After receiving the instructions, the chip may parse the content. According to the instruction type (e.g., vibration, rotation, and/or any other suitable type), the chip may adjust the motor drive through the PWM module, control the servo angle, and/or drive the stepper motor and other methods to achieve the corresponding stimulation actions.

Further in the exemplary disclosed working process, if the local area network connection is unstable, the Server API may be configured for instruction generation and transmission. After the platform server receives the reward event, the platform server may query the cloud mapping table to generate instructions. Any suitable API URL may be used (e.g., for using an HTTPS POST request). The request body may be in JSON format, which may contain ‘token’ (the developer token), ‘uid’ (the user ID), ‘command’ (the request type), ‘action’ (the control action and intensity), and any other suitable parameters. The platform server may directly push the instructions to the Connect APP on the model's intelligent mobile phone through the WebSocket long connection. The APP may set a priority mechanism, process (e.g., give priority to processing) the instructions from the platform server, cache the unexecuted instructions locally, and synchronize (e.g., automatically synchronize) them after the local area network is restored.

Another exemplary embodiment of the exemplary disclosed system and method follows, which involves collaborative control scenario of dual modules within the same model's mobile phone. The first functional entity may be a software module of the livestreaming plugin configured on the model's mobile phone (e.g., model device 525 that may be a mobile phone or any other suitable device such as for example as described herein) of the model user (e.g., the model user can access the livestreaming platform through this software module on this model's mobile phone). The second functional entity may be a software module for the connection of the sex toy configured on this model's mobile phone of the model user (configured to establish a communication connection with the sex toy for the model and to control the sex toy). An application program may be installed on the model's mobile phone, and this application program may be used to manage the communication connection and data transmission between the live streaming plugin software module and the software module for the connection of the sex toy. For example, the model may use the model's mobile phone to conduct a live broadcast, and an application integrating the live streaming function and the sex toy control function may be installed on the model's mobile phone. This application may include a live streaming plugin module and a sex toy connection module. The sex toy may maintain a connection with the model's mobile phone via Bluetooth, and the model's mobile phone may establish a communication connection with the platform server. The detailed working process of this scenario is described below.

In the exemplary disclosed working process, construction of module communication may be performed. For example, an initialization process may be performed. When the application is started, which may be through an inter-process communication mechanism provided by the device operating system (e.g., a Binder mechanism of Android or the XPC service of iOS), a communication channel may be created for the livestreaming plugin module and the sex toy connection module. At the same time, the sex toy configuration file may be loaded, and the file may contain information such as the device identification and the supported instruction set.

Further in the exemplary disclosed working process, connecting to the sex toy may be performed. The user may be guided to install a Connect APP on the model's mobile phone, and after opening the APP, pair the sex toy with this application. The sex toy connection module in the application may establish a Bluetooth connection with the sex toy through the Connect APP. The connection parameter settings may follow the configuration of the APP such as, for example, the connection interval, the timeout time, the reconnection strategy, and/or any other suitable settings to substantially ensure a relatively stable and low-power connection.

Further in the exemplary disclosed working process, data interaction optimization may be performed. Shared memory technology may be adopted to realize rapid transfer of data between modules. A specific-sized shared area may be opened up, and a semaphore may be used for synchronous control to substantially avoid data competition. By setting the data version number, the receiving party may obtain updated (e.g., and valid) data.

Further in the exemplary disclosed working process, livestreaming interaction and instruction processing may be performed. For example, livestreaming and rewards may be provided. The livestreaming plugin module may use the device camera and microphone to collect audio and video data and push the stream to the live streaming platform through a protocol such as RTMP. After the viewers provide rewards, the platform server may notify the livestreaming plugin module through the push service (e.g., via APNs), and the module may parse the notification to obtain the token quantity.

Further in the exemplary disclosed working process, instruction generation and conversion may be performed. The livestreaming plugin module may have a mapping table supporting conditional logic (e.g., built-in) and may generate instructions according to the token quantity. After generating the instructions (e.g., if the local APIs are used for control), the instructions may be converted into an appropriate format (e.g., according to the API specification). For example, the “Pattern” request may be used to control the complex action mode of the sex toy. When constructing the request body, the system may set ‘command’ to “Pattern” (e.g., ‘rule’ to define the protocol version, function combination, interval time, and any other suitable criteria). Also for example, ‘strength’ may set the action intensity sequence, ‘timeSec’ may determine the total running time, and/or any other suitable parameters may be used. Also, information such as the device ID may be added. The instructions may be transmitted to the sex toy connection module through the inter-process communication channel, and data compression may be performed during the transmission process to reduce the transmission volume.

Further in the exemplary disclosed working process, instruction transmission and device control may be performed (e.g., an instruction sending mechanism may be utilized). For example, the sex toy connection module may encapsulate the received instructions into Bluetooth characteristic values and may send them to the sex toy through the Connect APP, and configure the notification mode to obtain the device status feedback in real time (e.g., real time or near real time). When there is no instruction transmission, low-power mode may be entered, which may maintain the connection through the heartbeat packet, and may switch to the high-priority transmission mode after receiving the control instructions.

Further in the exemplary disclosed working process, response processing of the sex toy may be performed. After the main control chip of the sex toy receives the instructions, the chip may parse the instruction type and call the corresponding driver function to execute the action. At the same time, the chip may return the execution status to the Connect APP on the model's mobile phone via Bluetooth, and the APP may record the operation log for subsequent analysis.

Another exemplary embodiment of the exemplary disclosed system and method follows, which involves the model computer directly connecting to the built-in WiFi module of the sex toy. The first functional entity may be the model's computer (e.g., model computer 520) of the model user. The second functional entity may be the exemplary disclosed WiFi module built into the sex toy (e.g., model accessory 530) for the model. The WiFi module may have a communication connection with the control module of the sex toy and may be integrated inside the sex toy for the model (e.g., as a whole control system). In this way, the model's computer may directly establish a point-to-point communication connection with the sex toy for the model within this local area network through this WiFi module. For example, in a studio environment, the model user may use a plugin (e.g., a special browser plugin) installed on the model's computer to conduct a live broadcast. The sex toy may have a built-in WiFi module and may work in the AP mode. The model's computer may directly connect to the sex toy via WiFi to form an independent communication network, and the model's computer may establish a communication connection with the platform server. The detailed working process of this scenario is described below.

In the exemplary disclosed working process, a network connection may be established. Device discovery may be performed. For example, after the browser plugin of the model's computer is started, the plugin may search for the devices within the local area network by sending SSDP broadcast packets. The WiFi module of the sex toy may respond and return the XML description file of the device information, including the device name, the supported protocol version, and/or other contents.

Further in the exemplary disclosed working process, a connection may be established. WiFi Direct technology may be used to establish the connection. The model's computer may initiate a connection request, and the pairing may be completed through the WSC protocol (e.g., entering the PIN code). After the connection is successful, an IP address may be assigned and the subnet mask may be set. At the same time for example, WPA2 PSK encryption may be enabled, and a symmetric key may be negotiated through the Diffie Hellman algorithm to ensure communication security.

Further in the exemplary disclosed working process, connecting to the sex toy may be performed. The connection may be configured with the sex toy on the model's computer side, which can be done in any suitable manner (e.g., similar to a Connect PC operation logic). The model user may complete the relevant settings on the model's computer to enable the model's computer to establish a communication connection with the built-in WiFi module of the sex toy. If the API is used for control, communication rules of the local APIs may be followed and the communication domain name (such as 127 0 0 1.lovense. club) and the port number (such as httpsPort is 30010) may be determined.

Further in the exemplary disclosed working process, livestreaming interaction and instruction transmission may be performed. For example, control instruction generation may be performed. After the browser plugin obtains the reward tokens, it may generate instructions according to the mapping table, which may support multi-instruction combined control. The instruction generation may follow the local APIs specification and may be encapsulated in the corresponding data format. For example, a “Preset” request may be used to call the preset mode. When constructing the request body, ‘command’ may be set to “Preset”, ‘name’ may be used to select the preset mode name (such as “pulse”), ‘timeSec’ may set the running time, ‘toy’ may designate the toy ID (e.g., may be optional, and if not specified, it may apply to substantially all toys), and ‘api Ver’ may be set to 1. Transmission optimization may utilize the UDP protocol to transmit the instructions (e.g., and transmit them to the WiFi module of the sex toy).

Further in the exemplary disclosed working process, realization of sex toy control may be performed. The built-in chip of the sex toy may run a real-time operating system, create an instruction parsing task, parse the instructions received through the WiFi module of the sex toy, distribute the instructions to each functional module (e.g., vibration, lighting control module, and/or any other suitable functions) through the message queue, and control the work of each functional module. According to the instruction content, the chip may control the actions of the sex toy through the corresponding hardware drive circuit. For example, the chip may output a high-precision pulse signal to drive the vibration motor, transmit data to control the display of the LED light strip, and (e.g., at the same time) use the built-in sensor to monitor the actions of the toy in real time and return the status data.

In at least some exemplary disclosed embodiments, the exemplary disclosed system and method may be a Smart (e.g., Internet of Things) system and method including adult toys with built-in WiFi Modules that may automatically connect independently (e.g., without mobile device such as mobile phones or tablets). The exemplary disclosed system and method may enhance an autonomy and intelligence level of adult toys with built-in WiFi modules (e.g., for example the exemplary disclosed accessories). The exemplary disclosed system and method may allow for adult toys to operate without dependence on mobile devices and achieve automatic interconnection with other devices. For example, the exemplary disclosed adult toy may operate as an independent Internet of Things (IoT) device, and may establish a connection with a gateway (e.g., as described herein in the exemplary disclosed communication techniques) of the exemplary disclosed system via a built-in WiFi module (e.g., thereby accessing an entire IoT ecosystem).

In at least some exemplary disclosed embodiments, the exemplary disclosed adult toy may operate to automatically sense a user's surroundings (e.g., user's scene). For example, when a user wears the adult toy and enters a specific scene, the built-in sensors and algorithms of the adult toy may identify (e.g., quickly identify) environmental features. For example in surroundings such as house parties, clubs, or stripper clubs, the exemplary disclosed adult toy may automatically match and execute corresponding control patterns (e.g., such as vibrating or other exemplary disclosed control patterns) based on factors such as on-site music rhythm and an atmosphere (e.g., sounds, motion, density, and/or activity) of a crowd surrounding the user (e.g., without communication with a mobile device to participate in the exemplary disclosed control process).

In at least some exemplary disclosed embodiments, the exemplary disclosed system and method may provide for operation of the sex toy involving connecting to the exemplary disclosed network independently through the exemplary disclosed built-in WiFi module, which may allow for the exemplary disclosed adult toy to communicate directly with the exemplary disclosed devices described herein and/or other systems (e.g., smart homes, gateways, and/or other adult toys) without utilization of and/or communication with a mobile device.

In at least some exemplary disclosed embodiments, the exemplary disclosed system and method may operate in a long-distance situation or scenario. The exemplary disclosed adult toy may operate using enhanced communication connections via IoT devices (e.g., other smart devices), for example as opposed to utilizing a mobile device as an intermediary device. For example, after the exemplary disclosed adult toy is powered on, the adult toy may communicate directly with other adult toys and/or exemplary disclosed devices. For example in the long-distance scenario of communication between long-distance couples, after partners turn on their respective adult toys having built-in WiFi modules, the adult toys may automatically identify and establish a connection with each other without use of mobile devices such as phones. The established connection may provide remote interaction, which may expand an amount (e.g., significantly expand and/or increase versatile usage) of usage scenarios and convenience of the adult toys.

In at least some exemplary disclosed embodiments, the exemplary disclosed system and method may enhance usage of the Matter protocol for the exemplary disclosed smart sex toys. The exemplary disclosed system and method may utilize the Matter protocol to allow for the exemplary disclosed adult toy to automatically pair and connect with other home devices (e.g., IoT device) that may support this protocol such as, for example, smart lights and audio systems. Specifically, the exemplary disclosed adult toy, configured as a Matter-compliant endpoint device, leverages the protocol's standardized application layer over IPv6 networks (e.g., via Thread or Wi-Fi transports) to perform automated discovery through multicast DNS service discovery, secure commissioning with QR code or NFC-based setup for cryptographic key exchange using SPAKE2+ authentication, and interoperable data modeling with clusters (e.g., on/off, level control, color control) that enable bidirectional event subscriptions and command invocations across ecosystems; this facilitates rich integrations where the toy not only responds to but also initiates scenes by publishing attributes or events, such as broadcasting a “stimulation intensity” cluster that other devices subscribe to for coordinated actions, all managed through a fabric commissioner without vendor-specific silos. When the exemplary disclosed adult toy receives a specific signal, the toy may trigger effects such as, for example, a change of light color, a switching of music, and/or any other desired ambient effects, thereby creating a more immersive and intelligent user experience. For example, in an intimate bedroom scenario, activating a high-vibration mode on the adult toy sends a Matter command to dim smart lights to a romantic red hue, switch the audio system to a sensual playlist, and adjust a connected thermostat for warmer temperatures, with feedback loops where light sensors on the toy refine the ambiance in real-time; in a home office during a stressful workday, heart rate variability detected by the toy's biosensors triggers uplifting blue lights, motivational podcasts on speakers, and air purifier activation for clearer thinking; in a hotel suite with temporary Matter pairings via a mobile hub alternative (though independent of phones), the toy syncs with room service IoT panels to order mood-enhancing amenities like scented candles while controlling blinds for privacy; in a virtual reality gaming setup, the toy integrates with VR controllers and headsets to amplify haptic feedback, changing room lights to match virtual worlds and syncing audio for multi-sensory immersion; in a wellness spa at home, biofeedback from the toy (e.g., muscle tension) commands aromatherapy diffusers to release calming essences, speakers to play binaural beats, and humidifiers to create a misty atmosphere, evolving into programmable “therapy sessions” where users customize protocols for stress relief or energy boosts; or in a party hosting environment, crowd density inputs escalate toy patterns while orchestrating disco ball lights, fog machines, and multi-speaker soundscapes for synchronized group experiences, fostering social gameplay like “rhythm challenges” where devices compete or collaborate based on shared Matter events.

In at least some exemplary disclosed embodiments, the exemplary disclosed system and method may provide exemplary disclosed adult toys that operate using independent interconnection for example without mobile devices (e.g., as opposed to operating based on establishing a connection through a mobile phone app). For example, via a built-in WiFi module, the exemplary disclosed adult toy may directly access a local area network (e.g., LAN 535) or other suitable gateway and become an independent node in an Internet of Things (IoT) system. For example, in a gateway scenario, the exemplary disclosed adult toy may actively pair with a home router, a smart home hub (e.g., Amazon Alexa or Google Home), and/or other devices without use of a mobile device to relay the connection.

In at least some exemplary disclosed embodiments, the exemplary disclosed system and method may provide for scene adaptive control (e.g., based on a user's surroundings or scene). The exemplary disclosed adult toy may automatically trigger a preset mode (e.g., a predetermined mode) according to the user's environment (e.g., based on the exemplary disclosed adult toy identifying a user's environment based on sensors similar to the exemplary disclosed sensors, input, and/or artificial intelligence operations of the exemplary disclosed system and method). Specifically, the exemplary disclosed adult toy utilizes onboard processing units (e.g., microcontrollers with AI accelerators) to run sophisticated scene recognition pipelines, incorporating sensor data preprocessing (e.g., signal filtering and feature extraction using techniques like wavelet transforms for audio or principal component analysis for motion), followed by classification via embedded machine learning frameworks (e.g., TensorFlow Lite or custom models) that infer contexts from multimodal inputs and select from a configurable library of preset modes, with adaptive learning capabilities to refine patterns over time through on-device federated learning without data offloading, ensuring privacy and real-time responsiveness. For example in surroundings such as house parties or strip clubs where mobile devices may not be allowed, the adult toy may sense an on-site music rhythm and/or the user's actions through built-in sensors (e.g., microphones and/or accelerometers) and operate using preset vibration patterns (e.g., vibrating in synchronization with the bass of the music and/or any other desired control patterns) to achieve an immersive experience of control without used of a mobile device. For instance, in a lively house party, the toy analyzes beat per minute from music and user dance metrics to deploy escalating vibration sequences that peak with crowd energy, incorporating biofeedback like skin conductance for personalized intensity; in a dimly lit strip club, performance rhythms and audience reactions detected via audio peaks trigger anticipatory patterns that build tension, with options for “tease modes” that randomly vary to simulate unpredictability.

In at least some exemplary disclosed embodiments, the exemplary disclosed system and method may provide for cross-device collaboration. For example via a universal protocol (e.g., the Matter protocol), the exemplary disclosed adult toy may interact with smart home devices of different models or types (e.g., of different brands). Specifically, the exemplary disclosed adult toy harnesses the Matter protocol's device-agnostic architecture, utilizing its cluster-based data model for defining custom interactions (e.g., extending standard clusters like occupancy or media playback with toy-specific ones for haptic synchronization), enabling publish-subscribe patterns over secure, low-latency networks where events from disparate devices are aggregated and processed via the toy's logic engine to orchestrate complex, conditional scenes that adapt based on combined inputs, fostering emergent behaviors without centralized control. For example, when bedroom lights dim, the adult toy may automatically switch to a gentle mode, or when a smart speaker plays a specific song, the adult toy may adjust a vibration intensity according to the audio frequency (e.g., or operate in any other desired manner). For instance, in a cinematic home theater setup, a smart TV starting a romantic movie cues the adult toy to mirror emotional arcs through vibration gradients, while dimming multi-brand lights and syncing surround sound speakers for enveloping immersion; in a smart kitchen during meal prep, an oven timer completion signals the toy to celebrate with playful patterns, activating recipe-linked aroma diffusers and colorful under-cabinet lights from different vendors; in a hybrid workout space, data from a Peloton bike (via Matter bridge) informs the toy to intensify with heart rate, coordinating with fitness trackers and motivational lighting for cross-brand training sessions; in a security-integrated home, a doorbell camera detecting visitors pauses toy operations, flashes alert lights, and mutes speakers seamlessly; in a multi-room entertainment system, the toy propagates audio spatialization across incompatible speakers, creating directional haptics that “follow” sound sources for interactive storytelling.

As an illustrative example, a user wearing the exemplary disclosed adult toy that may have a built-in WiFi module may enter a smart home environment that supports the Matter protocol. The adult toy may automatically connect to a gateway of the home and synchronize with a smart speaker system and/or a smart lighting system of the home. For example when the user dances, the adult toy may operate to identify the rhythm through a sensor (e.g., as described above) and may adjust a vibration frequency of the adult toy in real-time without utilizing a mobile device for operation.

In at least some exemplary disclosed embodiments, the exemplary disclosed system and method may provide for adult toys that may serve as a communication hotspot for other devices to connect. For example, the built-in WiFi module of the sex toy may serve as a communication center, allowing the adult toy to actively connect to a network and also to serve as a hotspot for other devices to access the network and achieve remote control. For example, the adult toy may serve as a hotspot. The built-in WiFi chip of the adult toy may emit an independent signal, allowing external devices (e.g., mobile phones and/or tablets) to connect directly to the hotspot provided by the adult toy. For example in a commercial display scenario, the adult toy may serve as a core of an interactive showcase window, and the toy's WiFi may be searched for and connected to by other devices (e.g., tourists' or consumers' mobile phones).

In at least some exemplary disclosed embodiments, the exemplary disclosed system and method may provide localized control without utilization of a network. Through the exemplary disclosed hotspot function described above, the exemplary disclosed adult toy may build a local area network (e.g., its own LAN). For example even in an environment without internet coverage (e.g., outdoor activities, temporary location, remote locations, or similar areas), direct connection between devices may be provided for by the adult toy. For example, the toy of a first user may communicate directly with the toy of a second user via the hotspot without utilization of intermediate devices (e.g., a mobile device such as a mobile phone, a router, or similar devices).

In at least some exemplary disclosed embodiments, the exemplary disclosed system and method may provide for remote interaction and commercial application. For example, a model user performing on stage or in a showcase window may wear the exemplary disclosed adult toy, which includes a built-in WiFi module configured to operate as a hotspot, broadcasting WiFi hotspot signals to nearby users (e.g., tourists, consumers, or other suitable users) who are observing the model user's performance, thereby allowing their user devices (e.g., mobile phones, tablets, or other electronic communication devices) to establish a direct WiFi connection without requiring intermediate routers or external networks. Upon successful connection between a user's user device and the WiFi module of the model user's adult toy, various technical mechanisms can be employed to deliver interactive control capabilities: for instance, the adult toy's embedded fixed software program (e.g., firmware running on an onboard microcontroller) may directly serve and push control elements to the connected user device via a local web server hosted on the toy itself, utilizing protocols such as HTTP/HTTPS over the peer-to-peer link to render a dynamic control interface; alternatively, the connection may trigger a remote server (e.g., a cloud-based backend integrated with the system) to push the control elements to the user device through push notifications or WebSocket channels, leveraging device identifiers obtained during the hotspot association for targeted delivery; or, in a pre-configured setup, the user device may load predetermined control elements from a locally installed application or browser cache, activated upon detecting the specific hotspot SSID and authenticating via a shared secret or certificate exchange. Once provided, these control elements appear on the user interface of the user's user device, such as interactive widgets, sliders, buttons, or designated touch-sensitive control areas within a graphical user interface (e.g., similar to GUI 405), enabling the user to manipulate the adult toy remotely; specifically, when the user interacts with these control elements (e.g., via taps, swipes, or gestures), the user device captures the input, processes it through embedded logic or JavaScript scripts to convert it into standardized control instructions (e.g., formatted as JSON packets specifying vibration intensity, pattern, duration, or other stimulation parameters), and transmits these instructions back to the model user's adult toy over the established peer-to-peer communication data transmission link for immediate execution by the toy's control module. To enhance monetization and user engagement, the system incorporates integrated payment gating: for example, immediately after connection establishment (or upon initial attempts to interact with control elements), a prompt message may be pushed to the user device's interface, alerting the user (e.g., a tourist or consumer) that payment to the model user's account is required to unlock control privileges, potentially including tiered options for basic versus premium interactions; alternatively, the system may preemptively display a payment interface pre-bound to the model user's receivable account (e.g., linked to digital wallets, cryptocurrency addresses, or third-party payment processors like Stripe or PayPal), allowing seamless transaction processing via QR code scanning, NFC taps, or in-app purchases; only upon successful payment verification (e.g., confirmed through real-time API callbacks or blockchain confirmations), the system grants access, enabling the user to remotely control the model user's adult toy through the control elements and thus delivering a “paid interaction” process that fosters commercial viability. Of course, upon connection, the user interface of the user's user device can be triggered to simultaneously display both the payment interface and control elements (e.g., in a split-screen or modal overlay for immediate choice), or present them sequentially in any order (e.g., payment first for gated access, or controls with a paywall prompt upon interaction), with flexibility to adapt based on user preferences or system configurations. Another implementations include multi-user coordination where the hotspot supports concurrent connections from multiple devices, aggregating control instructions through a queuing or voting system (e.g., using priority algorithms to blend inputs for collaborative experiences); integration with augmented reality (AR) overlays on the user device, where control elements are superimposed on live camera feeds of the model user for enhanced immersion; blockchain-based smart contracts for automated royalty distributions post-payment; or AI-driven personalization, where the toy's sensors analyze the model user's responses to incoming instructions and suggest optimized patterns to payers in real-time. Furthermore, work processes can involve security measures such as end-to-end encryption for all transmissions, rate limiting to prevent abuse, and session timeouts tied to payment durations; scalability through hybrid local-cloud architectures, where edge computing on the toy handles low-latency controls while servers manage payment ledgers and analytics; or extensibility via APIs allowing third-party developers to customize control elements for branded experiences. As an illustrative example, in a high-energy nightclub performance, a model user on stage wears the exemplary disclosed adult toy with its built-in WiFi module broadcasting a hotspot signal detectable by patrons' mobile phones within the venue; upon connecting, the toy's firmware instantly serves a control page via a captive portal, displaying sliders for vibration modes and a prominent payment prompt requiring a $5 scan-to-pay via QR code linked to the model's digital wallet, after payment confirmation (processed in seconds through a server callback), the patron gains 5-minute access to send instructions like rhythmic pulses synced to the DJ's beat, with the toy's control module executing them to enhance the live show, while aggregated data from multiple payers could dynamically adjust intensity for crowd-driven climaxes, turning the interaction into a gamified, revenue-generating spectacle. In another illustrative example, during a virtual adult expo streamed online but with physical showcase elements, remote viewers connect their devices to the model user's toy hotspot via a bridged VPN or extended WiFi range (e.g., using mesh networking), triggering a server-pushed control interface with preloaded elements for low-bandwidth efficiency; a sequential display first shows a payment interface for tiered subscriptions (e.g., $10 for basic control, $20 for advanced patterns including heat or expansion), and upon cryptocurrency transaction verification on a blockchain ledger, unlocks real-time manipulation where user gestures on a touch area convert to instructions transmitted securely, allowing global participants to influence the model's performance in synchronized waves.

In at least some exemplary disclosed embodiments, the exemplary disclosed system and method may provide a mode for example as described above that enhances an interactivity between users and toys while allowing different device and platform types (e.g., different models and brands) to be used together. For example, smart home devices of different brands (e.g., that nominally may have incompatible communication protocols) may achieve unified control and interaction based on operation of the exemplary disclosed system (e.g., using protocols such as the Matter protocol and the exemplary disclosed adult toy hotspot for example as described herein). As an illustrative example, the exemplary disclosed system and method may be used for a smart showcase window display that contains smart toys, lights, displays, and/or other devices (e.g., of multiple types or brands). By connecting to the exemplary disclosed hotspot emitted by the adult toy, users (e.g., tourists, consumers, or other suitable users) may control these various devices simultaneously using one control page (e.g., similar to the exemplary disclosed control page described above). The users may control the devices to allow for the display elements in the showcase window to perform dynamically according to a set plot or rhythm (e.g., or any other suitable criteria), thereby providing users with an enjoyable interactive experience (e.g., and also providing an innovative marketing display method for merchants using the showcase windows for advertising).

As an illustrative example, the exemplary disclosed adult toy that may have a built-in WiFi hotspot may be placed in a showcase window of a sex products store, optionally worn by a mannequin or a live model. The specific technical workflow and interaction process may unfold as follows: The adult toy is activated, and its embedded WiFi module begins operating in Access Point (AP) mode, broadcasting a unique network identifier (SSID) such as “Store_Showcase_Interaction.” A user (e.g., a consumer's or tourist's) mobile phone within wireless range detects this SSID, and the user chooses to connect to it. Upon connection, a captive portal mechanism (e.g., DNS redirection or HTTP interception) is triggered by the network stack of the adult toy's control system or an associated gateway. This mechanism causes a control interface (e.g., similar to GUI 405) to be automatically provided, for example popping up in the phone's web browser. This interface may be hosted on a local web server within the toy or fetched from a remote server designated by the toy's control system. The control interface may initially present a payment gateway, often integrated with a QR code for scanning. After the user scans the code and makes a payment through a secured third-party payment service, a payment verification signal is sent to the control system (either directly or via a backend server). Upon successful verification, the interface updates in real-time, unlocking interactive control elements. The user may then adjust a vibration mode of the toy in real-time, for instance, by manipulating on-screen sliders for intensity, selecting from a list of predefined patterns, or drawing a custom intensity waveform on a touch-sensitive area. The user's input is converted into a corresponding control instruction by the browser or a local web app, which is then forwarded via the established peer-to-peer (P2P) communication data transmission link directly to the adult toy's WiFi module for execution. Furthermore, the interface may include a functionality to share control rights. Upon user activation, this feature may generate a time-limited session token or a unique temporary access code. Other users' (e.g., other consumers' or tourists') devices, such as mobile phones also connected to the same hotspot, can enter this code or follow a shared link within the local network. This action joins their devices to the same control session, forming a multi-person interactive experience. Control can be configured to be passed sequentially, operated collaboratively (e.g., combined input from multiple users determining the final command), or experienced in a spectator mode where others can view but not directly control. This exemplary disclosed function may also be utilized for long-distance intimate interaction between consenting partners. For example, adult toys of long-distance couples may each be configured with the other's hotspot SSID and credentials. When powered on within range (or configured for wide-area networking through intermediary internet-connected steps involving their respective hotspots), they may automatically establish a direct P2P communication link through each other's hotspots. Once linked, synchronization logic within their respective control systems operates. This could involve one toy streaming sensor data (e.g., from an integrated touch sensor) or command sequences as control instructions to the other in near real-time, causing the adult toys to operate (e.g., vibrate or operate using the other exemplary disclosed actions described herein) synchronously.

In an exemplary embodiment, the second control node, configured as the WiFi communication module embedded within the sex toy, operates in a software-enabled access point (AP) or hotspot mode. It broadcasts a dedicated wireless network with a specific Service Set Identifier (SSID), thereby establishing the same data transmission network—a localized peer-to-peer network. The first control node, being an electronic communication device such as a tourist's smartphone, obtains the network resource identifier (e.g., the SSID) of this hotspot, typically by discovering it in its list of available wireless networks. Upon user selection, the first control node connects to this SSID, thereby establishing the peer-to-peer communication data transmission link directly with the second control node, without routing through an intermediary router or the public internet. Following the connection, a captive portal process or a locally hosted web service is triggered. This causes a control interface, such as an interactive webpage, to be automatically provided or displayed on the first control node. This interface may integrate both a payment gateway and interactive control elements. A user of the first control node may complete a payment transaction through this interface. Upon successful payment verification, the control elements are activated. Subsequently, when the user interacts with these elements, the first control node generates and forwards a corresponding control instruction via the direct peer-to-peer link to the second control node. The second control node, which is integrated with the sex toy's control module, immediately forwards this instruction to the control module, which then drives actuators within the sex toy to perform a sexual stimulation operation (e.g., a specific vibration pattern) on the model user. As a specific illustrative example, consider the adult toy worn by a model in a store showcase window. The toy's embedded WiFi module acts as a hotspot with the SSID “Showcase _Interaction.” A consumer (the user) outside the window sees the SSID on their smartphone (the first control node), connects to it, and their browser automatically opens a control webpage. The page displays a QR code for payment and, after the consumer scans it and pays a fee, unlocks sliders and buttons for controlling vibration. When the consumer moves an intensity slider, their phone sends the corresponding command directly to the toy's hotspot. The toy's internal control system receives this command and immediately activates its motor to vibrate at the selected intensity, allowing the consumer to remotely control the model's experience in real-time through a direct, localized, and monetized peer-to-peer interaction.

In at least some exemplary disclosed embodiments, the exemplary disclosed method may be a method for controlling a sex toy. The method may include controlling the exemplary disclosed first control node (e.g., the first functional entity), which may include the exemplary disclosed model computer (e.g., model computer 520) or the exemplary disclosed livestreaming software program, to establish a communication connection with the exemplary disclosed livestreaming platform (e.g., via network 330). The method may also include generating a control instruction for the sex toy of a model user in response to an interactive event initiated by a viewer user of the livestreaming platform toward the model user (e.g., a viewer tipping the model). The method may also include controlling the first control node (e.g., the first functional entity) to obtain a network resource identifier (e.g., the IP address of the model device such as a mobile phone, the domain name of the model mobile phone, or the functional port of the toy connection software program) of the exemplary disclosed second control node (e.g., the second functional entity), which may be the exemplary disclosed model device such as a mobile phone, a toy connection software program, or the WiFi module of the sex toy. The first control node (e.g., the first functional entity) and the second control node (e.g., the second functional entity) may both be located within a same data transmission network (e.g., LAN 535). For example, the model computer and the model device (e.g., mobile device such as a mobile phone) may be on the same LAN, or the exemplary disclosed livestreaming software program and the toy connection software program may be configured within the data transmission architecture of the same device. The same data transmission network (e.g., LAN 535) may be configured to allow the first control node (e.g., the first functional entity) and the second control node (e.g., the second functional entity) to transmit data in a peer-to-peer communication manner. The second control node (e.g., the second functional entity) may establish a wired or wireless communication link with the exemplary disclosed control module embedded in the model user's sex toy. The method may also include controlling the first control node (e.g., the first functional entity) to establish a peer-to-peer communication data transmission link with the second control node (e.g., the second functional entity) based on the obtained network resource identifier of the second control node (e.g., the second functional entity). The method may also include controlling the first control node (e.g., the first functional entity) to send the control instruction to the second control node (e.g., the second functional entity) via the data transmission link, so that the second control node (e.g., the second functional entity) forwards the control instruction to the control module of the sex toy via the communication link (e.g., thereby controlling the sex toy to perform a sexual stimulation operation on the model user based on the control instruction).

In at least some exemplary disclosed embodiments, the exemplary disclosed method may allow for a first control node (e.g., the first functional entity) that may be a model computer and a second control node (e.g., the second functional entity) that may be a model device (e.g., mobile device such as a mobile phone) to establish a peer-to-peer communication connection within a local area network (e.g., LAN 535). The exemplary disclosed method may also allow for a first control node (e.g., the first functional entity) that may be a model computer and a second control node (e.g., the second functional entity) that may be a sex toy with an integrated WiFi module to directly establish a communication connection within a LAN (e.g., LAN 535). The exemplary disclosed method may also allow for a model computer or a model device (e.g., mobile device 49 such as a model mobile phone) or other livestreaming terminal to integrate both a livestreaming functional module as the first control node (e.g., the first functional entity) and a sex toy connection functional module as the second control node (e.g., the second functional entity).

In at least some exemplary disclosed embodiments, the first control node (e.g., the first functional entity) that may be a model computer and the second control node (e.g., the second functional entity) that may be a model device (e.g., model mobile device such as a mobile phone) may be different electronic communication devices. The exemplary disclosed network resource identifier may be configured as a domain name or Uniform Resource Locator. For example, the model computer may establish a connection with the model device (e.g., mobile phone) within a LAN (e.g., LAN 535) using a domain name or URL (Uniform Resource Locator).

In at least some exemplary disclosed embodiments, the first control node (e.g., the first functional entity) that may be a model computer and the second control node (e.g., the second functional entity) that may be a model device (e.g., model mobile device such as a mobile phone) may be different electronic communication devices, and the exemplary disclosed network resource identifier may be configured as an IP address. Controlling the first control node (e.g., the first functional entity) to obtain the network resource identifier of the second control node (e.g., the second functional entity) may include controlling the first control node (e.g., the first functional entity) to obtain the domain name of the second control node (e.g., the second functional entity) and to initiate an IP query request for the second control node (e.g., the second functional entity) to a DNS server system (e.g., via DNS server 515). The DNS server system may be configured to convert the domain name of the second control node (e.g., the second functional entity) into the IP address of the second control node (e.g., the second functional entity) based on the IP query request. Controlling the first control node (e.g., the first functional entity) to obtain the network resource identifier of the second control node (e.g., the second functional entity) may also include controlling the first control node (e.g., the first functional entity) to receive the IP address of the second control node (e.g., the second functional entity) resolved by the DNS server system.

In at least some exemplary disclosed embodiments, the domain name of the second control node (e.g., the second functional entity) may be configured (e.g., from left to right) as a subdomain, a second-level domain, and a top-level domain. The subdomain may be configured as the IP address of the second functional entity in a predetermined encoding format. The DNS server system may not perform domain name resolution on the domain name of the second control node (e.g., the second functional entity) to obtain the IP address of the second control node (e.g., the second functional entity), but instead may directly convert the subdomain of the domain name of the second control node (e.g., the second functional entity) into the IP address of the second control node (e.g., the second functional entity) using a decoding format corresponding to the predetermined encoding format. The exemplary disclosed system may thereby provide a process (e.g., including a rule) for converting a domain name into an IP address. As an illustrative example, the second control node (e.g., the second functional entity) may be a model device (e.g., mobile device such as a model mobile phone), and its domain name may be 192-168-0-11.lovense. club. The subdomain “192-168-0-11” may be converted into “192.168.0.11” to obtain the IP address of the model device (e.g., model mobile phone).

In at least some exemplary disclosed embodiments, when the first control node (e.g., the first functional entity) establishes a peer-to-peer communication data transmission link with the second control node (e.g., the second functional entity), the second control node (e.g., the second functional entity) may first check itself as to whether the domain name in the certificate matches the target domain name requested by the second control node (e.g., the second functional entity) and whether the certificate is valid. The second control node (e.g., the second functional entity) may establish the peer-to-peer communication data transmission link with the first control node (e.g., the first functional entity) after the certificate verification is passed. For example, during establishment of the connection between the model computer and the model device (e.g., mobile phone), the HTTPS certificate SSL may be first verified on the mobile phone side.

In at least some exemplary disclosed embodiments, after the first control node (e.g., the first functional entity) obtains the IP address of the second control node (e.g., the second functional entity), the first control node (e.g., the first functional entity) may cache or save the IP address of the second control node (e.g., the second functional entity), which may substantially avoid frequent retrieval of the IP address.

In at least some exemplary disclosed embodiments, the first control node (e.g., the first functional entity) may be a model computer (e.g., on which an application such as the exemplary disclosed livestreaming software program is installed) configured to manage the communication connection and data transmission between the first control node (e.g., the first functional entity) and the second control node (e.g., the second functional entity) that may be a model device (e.g., model mobile phone). The first control node (e.g., the first functional entity) may be the exemplary disclosed model computer (e.g., model computer 520 such as the model user's personal computer), and the second control node (e.g., the second functional entity) may be the model device (e.g., model device 525 such as the model user's mobile communication device). The first control node (e.g., the first functional entity) that may be the model computer and the second control node (e.g., the second functional entity) that may be a model mobile device (e.g., phone) may establish a direct connection within a LAN.

In at least some exemplary disclosed embodiments, the first control node (e.g., the first functional entity) and the second control node (e.g., the second functional entity) may be different software functional modules configured on the same electronic communication device of the model user (e.g., model computer 520 or model device 525). An application configured to manage the connection and data transmission between the first control node (e.g., the first functional entity) and the second control node (e.g., the second functional entity) may be installed on the electronic communication device. For example, the model terminal device (e.g., model computer 520 or model device 525) may integrate both the exemplary disclosed livestreaming function module (e.g., cam functional module) as the first control node (e.g., the first functional entity) and the exemplary disclosed toy connect functional module as the second control node (e.g., the second functional entity), thereby providing two software functionalities.

In at least some exemplary disclosed embodiments, the first control node (e.g., the first functional entity) may be an electronic communication device, and the second control node (e.g., the second functional entity) may be configured as a WiFi communication module embedded in the sex toy. The second control node (e.g., the second functional entity) and the control module of the sex toy may be integrated as a control system embedded within the exemplary disclosed sex toy. For example, the exemplary disclosed model terminal device (e.g., model computer 520 or model device 525) that may serve as the first control node (e.g., the first functional entity) and the sex toy having an integrated WiFi module that may serve as the second control node (e.g., the second functional entity) may establish a direct connection within a LAN (e.g., LAN 535).

In at least some exemplary disclosed embodiments, generating the control instruction for the model user's sex toy in response to an interactive event initiated by a viewer user of the livestreaming platform toward the model user (e.g., a viewer tipping the model) may include processing (e.g., crawling) the interactive event initiated by the viewer user toward the model user on the livestreaming platform using a crawling program, and generating the control instruction for the model user's sex toy based on a mapping relationship between the interactive event and the control instruction of the sex toy. For example, the model computer that may serve as the first control node (e.g., the first functional entity) and the sex toy having an integrated WiFi module that may serve as the second control node (e.g., the second functional entity) may establish a direct connection within a LAN.

In at least some exemplary disclosed embodiments, the interactive event may include a tipping operation performed by the viewer user toward the model user on the livestreaming platform, and the control instruction of the sex toy may be associated with a tipping amount of the tipping operation. For example, the model computer that may serve as the first control node (e.g., the first functional entity) and the sex toy having an integrated WiFi module that may serve as the second control node (e.g., the second functional entity) may establish a direct connection within a LAN.

In at least some exemplary disclosed embodiments, the exemplary disclosed method may include controlling a first control node (e.g., the first functional entity) that may be a model computer or a model device (e.g., mobile device such as a mobile phone, tablet, or other exemplary disclosed device described herein) to obtain a network resource identifier (e.g., the IP address of the model device such as a mobile phone or the port of the Connect application) of a second control node (e.g., the second functional entity) that may be the WiFi module of the sex toy. The first control node (e.g., the first functional entity) and the second control node (e.g., the second functional entity) may both be located within the same data transmission network. For example, the model computer and the model sex toy may be on the same LAN (e.g., LAN 535), or the router and the viewer's toy may be on the same LAN). The same data transmission network may be configured to allow the first control node (e.g., the first functional entity) and the second control node (e.g., the second functional entity) to transmit data in a peer-to-peer communication manner. The second control node (e.g., the second functional entity) may establish a wired or wireless communication link with the control module embedded in the model user's sex toy. The first control node (e.g., the first functional entity) may be an electronic communication device, and the second control node (e.g., the second functional entity) may be configured as a WiFi communication module embedded in the sex toy, with the second control node (e.g., the second functional entity) and the control module of the sex toy integrated as a control system embedded within the sex toy. The exemplary disclosed method may also include controlling the first control node (e.g., the first functional entity) to establish a peer-to-peer communication data transmission link with the second control node (e.g., the second functional entity) based on the obtained network resource identifier of the second control node (e.g., the second functional entity). The exemplary disclosed method may also include controlling the first control node (e.g., the first functional entity) to forward a control instruction sent by another communication device to the second control node (e.g., the second functional entity) via the data transmission link, so that the second control node (e.g., the second functional entity) forwards the control instruction to the sex toy via the communication link (e.g., thereby controlling the sex toy to perform a sexual stimulation operation on the model user based on the control instruction). For example, the exemplary disclosed sex toy may have a built-in WiFi module and may establish direct communication connections with other communication devices.

In at least some exemplary disclosed embodiments, the exemplary disclosed WiFi communication module may be configured as a communication hotspot for other user devices to establish communication connections. For example, the WiFi module may be built into the sex toy and may serve as a communication hotspot to which other electronic devices may connect.

The invention includes other illustrative embodiments (“Embodiments”) as follows.

Embodiment 1: A method for controlling a sex toy of a model user, comprising: controlling a first control node to establish a communication connection with a livestreaming platform; generating a control instruction for the sex toy of the model user in response to an interactive event initiated by a viewer user of the livestreaming platform toward the model user; controlling the first control node to obtain a network resource identifier of a second control node; wherein the first control node and the second control node are both located within a same data transmission network, and the same data transmission network is configured to allow the first control node and the second control node to transmit data via peer-to-peer communication; wherein the second control node establishes a communication link, which is wired or wireless, with a control module embedded in the sex toy of the model user; controlling the first control node to establish a peer-to-peer communication data transmission link with the second control node based on the network resource identifier of the second control node; and controlling the first control node to send the control instruction to the second control node via the peer-to-peer communication data transmission link, so that the second control node forwards the control instruction to the control module embedded in the sex toy via the communication link, thereby controlling the sex toy to perform a sexual stimulation operation on the model user based on the control instruction.

Embodiment 2: The method of Embodiment 1, wherein the first control node and the second control node are different electronic communication devices, and the network resource identifier is configured as a domain name or a Uniform Resource Locator (URL).

Embodiment 3: The method of Embodiment 1, wherein: the first control node and the second control node are different electronic communication devices, and the network resource identifier is configured as an IP address; and controlling the first control node to obtain the network resource identifier of the second control node includes: controlling the first control node to obtain a domain name of the second control node and initiate an IP query request for the second control node to a DNS server system, wherein the DNS server system is configured to convert the domain name of the second control node into the IP address of the second control node based on the IP query request; and controlling the first control node to receive the IP address of the second control node resolved by the DNS server system.

Embodiment 4: The method of Embodiment 3, wherein the domain name of the second control node is configured from left to right as a subdomain, a second-level domain, and a top-level domain, and the subdomain is configured as the IP address of the second control node in a predetermined encoding format; and instead of the DNS server system performing domain name resolution on the domain name of the second control node to obtain the IP address of the second control node, the DNS server directly converts the subdomain of the domain name of the second control node into the IP address of the second control node using a decoding format corresponding to the predetermined encoding format.

Embodiment 5: The method of Embodiment 3, wherein when the first control node establishes the peer-to-peer communication data transmission link with the second control node, the second control node first checks itself as to whether the domain name in a certificate matches a target domain name requested by the second control node and whether the certificate is valid, and establishes the peer-to-peer communication data transmission link with the first control node after the certificate passes verification.

Embodiment 6: The method of Embodiment 3, wherein after the first control node obtains the IP address of the second control node, the first control node caches or saves the IP address of the second control node.

Embodiment 7: The method of Embodiment 1, wherein: an application configured to manage the communication connection and data transmission between the first control node and the second control node is installed on the first control node; the first control node is a personal computer of the model user; and the second control node is a mobile communication device of the model user.

Embodiment 8: The method of Embodiment 1, wherein: the first control node and the second control node include different software functional modules configured on a same electronic communication device of the model user; and an application configured to manage connection and data transmission between the first control node and the second control node is installed on the same electronic communication device.

Embodiment 9: The method of Embodiment 1, wherein: the first control node is an electronic communication device; and the second control node is configured as a WiFi communication module embedded in the sex toy, with the second control node and the control module embedded in the sex toy integrated as a control system embedded within the sex toy.

Embodiment 10: The method of Embodiment 1, wherein generating the control instruction for the sex toy of the model user in response to the interactive event initiated by the viewer user of the livestreaming platform toward the model user includes: processing including crawling the interactive event initiated by the viewer user toward the model user on the livestreaming platform using a crawling program; and generating the control instruction for the sex toy of the model user based on a mapping relationship between the interactive event and the control instruction of the sex toy.

Embodiment 11: The method of Embodiment 10, wherein: the interactive event includes a tipping operation performed by the viewer user toward the model user on the livestreaming platform; and the control instruction of the sex toy is associated with a tipping amount of the tipping operation.

Embodiment 12: A method for controlling a sex toy of a model user, comprising: controlling a first control node to obtain a network resource identifier of a second control node; wherein the first control node and the second control node are both located within a same data transmission network, and the same data transmission network is configured to allow the first control node and the second control node to transmit data via peer-to-peer communication; wherein the second control node establishes a communication link, which is wired or wireless, with a control module embedded in the sex toy of the model user; wherein the first control node is an electronic communication device, and the second control node is configured as a WiFi communication module embedded in the sex toy, with the second control node and the control module of the sex toy integrated as a control system embedded within the sex toy; controlling the first control node to establish a peer-to-peer communication data transmission link with the second control node based on the network resource identifier of the second control node; and controlling the first control node to forward a control instruction to the second control node via the peer-to-peer communication data transmission link, so that the second control node forwards the control instruction to the control module via the communication link, thereby controlling the sex toy to perform a sexual stimulation operation on the model user based on the control instruction.

Embodiment 13: The method of Embodiment 12, wherein the WiFi communication module is configured as a WiFi hotspot for nearby user devices to use in establishing communication connections, allowing the first control node to discover and connect to the second control node via the WiFi hotspot without an intermediate router or access point.

Embodiment 14: The method of Embodiment 12, wherein the method further comprises: in response to the first control node connecting to the WiFi hotspot, providing a control element to the first control node, wherein the control element is configured to displayed on a user interface of the first control node; and wherein the control element is configured to allow a user of the first control node to operate on the user interface to control the sex toy of the model user. In at least some exemplary embodiments, the user interface comprises a payment interface configured to receive a payment from a user of the first control node; and the method further comprises: receiving a payment from the first control node; and unlocking a control permission for the first control node to forward the control instruction to the second control node in response to verifying the payment. In at least some exemplary embodiments, the control instruction of the sex toy is associated with a tipping amount of a tipping operation of a user toward the model user.

Embodiment 15: A system for controlling a sex toy of a model user, comprising: at least one module comprising computer-executable code stored in non-volatile memory; and a memory for storing instructions and a processor for executing the instructions; wherein the computer-executable code, when operating on the processor, causes the system to: control a first control node to establish a communication connection with a livestreaming platform; generate a control instruction for the sex toy of the model user in response to an interactive event initiated by a viewer user of the livestreaming platform toward the model user; control the first control node to obtain a network resource identifier of a second control node; wherein the first control node and the second control node are both located within a same data transmission network, and the same data transmission network is configured to allow the first control node and the second control node to transmit data via peer-to-peer communication; wherein the second control node establishes a communication link, which is wired or wireless, with a control module embedded in the sex toy of the model user; control the first control node to establish a peer-to-peer communication data transmission link with the second control node based on the network resource identifier of the second control node; and control the first control node to send the control instruction to the second control node via the peer-to-peer communication data transmission link, so that the second control node forwards the control instruction to the control module embedded in the sex toy via the communication link, thereby controlling the sex toy to perform a sexual stimulation operation on the model user based on the control instruction.

Embodiment 16: The method of Embodiment 15, wherein the first control node and the second control node are different electronic communication devices, and the network resource identifier is configured as a domain name or a Uniform Resource Locator (URL).

Embodiment 17: The method of Embodiment 15, wherein: the first control node and the second control node are different electronic communication devices, and the network resource identifier is configured as an IP address; and controlling the first control node to obtain the network resource identifier of the second control node includes: controlling the first control node to obtain a domain name of the second control node and initiate an IP query request for the second control node to a DNS server system, wherein the DNS server system is configured to convert the domain name of the second control node into the IP address of the second control node based on the IP query request; and controlling the first control node to receive the IP address of the second control node resolved by the DNS server system.

Embodiment 18: The method of Embodiment 17, wherein: the domain name of the second control node is configured from left to right as a subdomain, a second-level domain, and a top-level domain, and the subdomain is configured as the IP address of the second control node in a predetermined encoding format; and instead of the DNS server system performing domain name resolution on the domain name of the second control node to obtain the IP address of the second control node, the DNS server directly converts the subdomain of the domain name of the second control node into the IP address of the second control node using a decoding format corresponding to the predetermined encoding format.

Embodiment 19: The method of Embodiment 17, wherein when the first control node establishes the peer-to-peer communication data transmission link with the second control node, the second control node first checks itself as to whether the domain name in a certificate matches a target domain name requested by the second control node and whether the certificate is valid, and establishes the peer-to-peer communication data transmission link with the first control node after the certificate passes verification.

Embodiment 20: The method of Embodiment 17, wherein after the first control node obtains the IP address of the second control node, the first control node caches or saves the IP address of the second control node.

The exemplary disclosed system and method may provide an efficient and effective technique for transferring control instructions to adult toys without substantial or significant delay. The exemplary disclosed system and method may also provide an efficient and effective technique transferring control instructions to adult toys via a control link that is relatively stable. For example, the exemplary disclosed system and method may provide control of adult toys in which the control delay for model toys is relatively low and the control link is relatively stable and reliable.

In at least some exemplary embodiments, the exemplary disclosed system and method may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

An illustrative representation of a computing device appropriate for use with embodiments of the system of the present disclosure is shown in FIG. 10. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 11, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 11, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 11, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

1. A method for controlling a sex toy of a model user, comprising:
controlling a first control node to establish a communication connection with a livestreaming platform;
generating a control instruction for the sex toy of the model user in response to an interactive event initiated by a viewer user of the livestreaming platform toward the model user;
controlling the first control node to obtain a network resource identifier of a second control node;
wherein the first control node and the second control node are both located within a same data transmission network, and the same data transmission network is configured to allow the first control node and the second control node to transmit data via peer-to-peer communication;
wherein the second control node establishes a communication link with a control module embedded in the sex toy of the model user;
controlling the first control node to establish a peer-to-peer communication data transmission link with the second control node based on the network resource identifier of the second control node; and
controlling the first control node to send the control instruction to the second control node via the peer-to-peer communication data transmission link, so that the second control node forwards the control instruction, which was received via the peer-to-peer communication data transmission link, to the control module embedded in the sex toy via the communication link, thereby enabling the control module to control the sex toy to perform a sexual stimulation operation on the model user based on the control instruction.

2. The method of claim 1, wherein the first control node and the second control node are different electronic communication devices, and the network resource identifier is configured as a domain name or a Uniform Resource Locator (URL).

3. The method of claim 1, wherein:
the first control node and the second control node are different electronic communication devices, and the network resource identifier is configured as an IP address; and
controlling the first control node to obtain the network resource identifier of the second control node comprises:
controlling the first control node to obtain a domain name of the second control node and initiate an IP query request for the second control node to a DNS server system, wherein the DNS server system is configured to convert the domain name of the second control node into the IP address of the second control node based on the IP query request; and
controlling the first control node to receive the IP address of the second control node resolved by the DNS server system.

4. The method of claim 3, wherein:
the domain name of the second control node includes a subdomain, a second-level domain, and a top-level domain, and the subdomain is configured as the IP address of the second control node in a predetermined encoding format; and
the DNS server directly converts the subdomain of the domain name of the second control node into the IP address of the second control node using a decoding format corresponding to the predetermined encoding format.

5. The method of claim 3, wherein when the first control node establishes the peer-to-peer communication data transmission link with the second control node, the second control node first checks itself as to whether the domain name in a certificate matches a target domain name requested by the second control node and whether the certificate is valid, and establishes the peer-to-peer communication data transmission link with the first control node after the certificate passes verification.

6. The method of claim 3, wherein after the first control node obtains the IP address of the second control node, the first control node caches or saves the IP address of the second control node.

7. The method of claim 1, wherein:
an application configured to manage the communication connection and data transmission between the first control node and the second control node is installed on the first control node;
the first control node is a personal computer of the model user; and
the second control node is a mobile communication device of the model user.

8. The method of claim 1, wherein:
the first control node and the second control node include different software functional modules configured on a same electronic communication device of the model user; and
an application configured to manage connection and data transmission between the first control node and the second control node is installed on the same electronic communication device.

9. The method of claim 1, wherein:
the first control node is an electronic communication device; and
the second control node is configured as a WiFi communication module embedded in the sex toy, with the second control node and the control module embedded in the sex toy integrated as a control system embedded within the sex toy.

10. The method of claim 1, wherein generating the control instruction for the sex toy of the model user in response to the interactive event initiated by the viewer user of the livestreaming platform toward the model user comprises:
processing including crawling the interactive event initiated by the viewer user toward the model user on the livestreaming platform using a crawling program; and
generating the control instruction for the sex toy of the model user based on a mapping relationship between the interactive event and the control instruction of the sex toy.

11. The method of claim 10, wherein:
the interactive event includes a tipping operation performed by the viewer user toward the model user on the livestreaming platform; and
the control instruction of the sex toy is associated with a tipping amount of the tipping operation.

12. A method for controlling a sex toy of a model user, comprising:
controlling a first control node to obtain a network resource identifier of a second control node;
wherein the first control node and the second control node are both located within a same data transmission network, and the same data transmission network is configured to allow the first control node and the second control node to transmit data via peer-to-peer communication;
wherein the second control node establishes a communication link, which is wired or wireless, with a control module embedded in the sex toy of the model user;
wherein the first control node is an electronic communication device, and the second control node is configured as a WiFi communication module embedded in the sex toy, with the second control node and the control module of the sex toy integrated as a control system embedded within the sex toy;
controlling the first control node to establish a peer-to-peer communication data transmission link with the second control node based on the network resource identifier of the second control node; and
controlling the first control node to forward a control instruction to the second control node via the peer-to-peer communication data transmission link, so that the second control node forwards the control instruction, which was received via the peer-to-peer communication data transmission link, to the control module via the communication link, thereby controlling the sex toy to perform a sexual stimulation operation on the model user based on the control instruction.

13. The method of claim 12, wherein the WiFi communication module is configured as a WiFi hotspot for nearby user devices to use in establishing communication connections, allowing the first control node to discover and connect to the second control node via the WiFi hotspot without an intermediate router or access point.

14. The method of claim 13, further comprising:
in response to the first control node connecting to the WiFi hotspot, providing a control element to the first control node, wherein the control element is configured to be displayed on a user interface of the first control node; and
wherein the control element is configured to allow a user of the first control node to operate on the user interface to control the sex toy of the model user.

15. The method of claim 13, wherein the user interface comprises a payment interface configured to receive a payment from a user of the first control node; and the method further comprises:
receiving a payment from the first control node; and
unlocking a control permission for the first control node to forward the control instruction to the second control node in response to verifying the payment.

16. The method of claim 15, wherein the control instruction of the sex toy is associated with a tipping amount of a tipping operation of a user toward the model user.

17. A system for controlling a sex toy of a model user, comprising:
at least one module comprising computer-executable code stored in non-volatile memory; and
a memory for storing instructions and a processor for executing the instructions;
wherein the computer-executable code, when operating on the processor, causes the system to:
control a first control node to establish a communication connection with a livestreaming platform;
generate a control instruction for the sex toy of the model user in response to an interactive event initiated by a viewer user of the livestreaming platform toward the model user;
control the first control node to obtain a network resource identifier of a second control node;
wherein the first control node and the second control node are both located within a same data transmission network, and the same data transmission network is configured to allow the first control node and the second control node to transmit data via peer-to-peer communication;
wherein the second control node establishes a communication link, which is wired or wireless, with a control module embedded in the sex toy of the model user;
control the first control node to establish a peer-to-peer communication data transmission link with the second control node based on the network resource identifier of the second control node; and
control the first control node to send the control instruction to the second control node via the peer-to-peer communication data transmission link, so that the second control node forwards the control instruction, which was received via the peer-to-peer communication data transmission link, to the control module embedded in the sex toy via the communication link, thereby controlling the sex toy to perform a sexual stimulation operation on the model user based on the control instruction.

18. The system of claim 17, wherein the first control node and the second control node are different electronic communication devices, and the network resource identifier is configured as a domain name or a Uniform Resource Locator (URL).

19. The system of claim 17, wherein:
the first control node and the second control node are different electronic communication devices, and the network resource identifier is configured as an IP address; and
controlling the first control node to obtain the network resource identifier of the second control node includes:
controlling the first control node to obtain a domain name of the second control node and initiate an IP query request for the second control node to a DNS server system, wherein the DNS server system is configured to convert the domain name of the second control node into the IP address of the second control node based on the IP query request; and
controlling the first control node to receive the IP address of the second control node resolved by the DNS server system.

20. The system of claim 19, wherein:
the domain name of the second control node is configured from left to right as a subdomain, a second-level domain, and a top-level domain, and the subdomain is configured as the IP address of the second control node in a predetermined encoding format; and
instead of the DNS server system performing domain name resolution on the domain name of the second control node to obtain the IP address of the second control node, the DNS server directly converts the subdomain of the domain name of the second control node into the IP address of the second control node using a decoding format corresponding to the predetermined encoding format.
